(19) United States
(12) Patent Application Publication
(10) Pub. No.: US 2008/0141323 A1
(43) Pub. Date: Jun. 12, 2008

(54) CONTENT INFORMATION OUTPUTTING APPARATUS, CONTENT INFORMATION RECEIVING APPARATUS, CONTENT INFORMATION OUTPUTTING METHOD, CONTENT INFORMATION RECEIVING METHOD

(75) Inventors: Toshihiko MUNETSUGU, Osaka (JP); Yuki HORII, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/953,981

(22) Filed: Dec. 11, 2007

Related U.S. Application Data
(60) Provisional application No. 60/869,632, filed on Dec. 12, 2006.

(51) Int. Cl. H04N 7/00

(52) U.S. Cl. 725/115

(57) ABSTRACT

The content information outputting apparatus according to the present invention includes: a storage unit for storing multimedia contents; a transmitting and receiving unit; a message processing unit which extracts, from a request message, a search condition from a terminal; a content searching unit which searches for a media content, based on the search condition and at least one of an attribute of the multimedia content and an attribute of the terminal; and a judgment unit which judges whether or not the multimedia content searched-out by the content searching unit can be outputted, based on an attribute of the multimedia content, and the attribute of the terminal. The message processing unit generates a content list message of only the multimedia contents that are judged as capable of being outputted, and the transmitting and receiving unit transmits the content list message to the terminal.

### BACKGROUND OF THE INVENTION

(1) Field of the Invention

The present invention relates to the outputting of multimedia digital content to a network, and the like, and the control thereof.

(2) Description of the Related Art

In recent years, digital broadcasting such as BS digital broadcasting, CS 110-degree digital broadcasting, and digital terrestrial broadcasting has commenced. Furthermore, DVR for recording a TV-program in a recording medium for digital data such as a Hard Disk Drive (HDD), a Blu-Ray Disc (BD), and a Digital Versatile Disc (DVD) is becoming popular. With this, digitalized multimedia content that can be used in households is increasing.

Meanwhile, with the development of the broadband environment, internet access from households is becoming widespread. Accordingly, the spread of the so-called home network, in which the respective rooms in a house are connected by an IP network, is also advancing.

With such a situation, digital broadcasts received by a digital broadcast receiver in the house, or digital contents stored in a recorder can now be viewed at other rooms, using the home network.

With regard to such sharing of digital content using a home network, there is a move to make this possible not only between the above-mentioned CE devices, but also between all devices connected to a home network, including personal computers (PC) and portable information terminals referred to as Personal Digital Assistants (PDA). To be more specific, standardization organizations such as the Digital Living Network Alliance (DLNA) have laid-out and made public standards and implementing guidelines for this purpose.

In such content sharing, the method defined in Universal Plug and Play (UPnP) is widely used in the mutual recognition of the devices and the exchange of information on the contents that can be used, between a server (for example, a set top box or DVR which receives digital broadcasts) and a client (for example, a personal computer or a digital player) in the home network. In particular, a method defined in UPnP AV Architecture (UPnP AV) is used in the exchange of information on the content provided from the server. In UPnP AV, upon receiving an inquiry from the client, the server replies with a list of provided contents and the attributes of each of the contents.

In such content sharing in a home network, with regard to contents requiring protection of copyrights and the like, such as broadcast contents, there is a need for the restriction of terminals that can use such contents. In other words, there is a need to make only a device equipped with a specific protection technique or a client device acknowledged by the right holder, capable of using such contents.

Furthermore, with regard to the protection condition for the broadcast contents, the condition is set in advance prior to broadcasting. Therefore, a DVR refers to the condition during recording, and the protection condition of the recorded content is established. A condition established in such manner is not open to change.

On the other hand, with the increase in capacity of HDDs and the spread of home networks, a single DVR capable of long hours of recording may be used from plural locations within the home. Here, a recoding request is sent to one DVR from PCs or STBs in different rooms, and the DVR carries out the recording therefor. In addition, the recorded content is viewed by the clients through the home network. In this case too, the above-mentioned UPnP and UPnP AV are used in the viewing by the clients.

With regard to such DVR sharing using a home network, it is preferable, from the point of view of privacy protection, that a TV-program recorded according to the request from a specific user or client be useable only to such user or client.

### SUMMARY OF THE INVENTION

However, in the obtainment of the provided content list according to the above-mentioned UPnP AV, generally, the server makes a reply without judging whether or not the client making the inquiry can use such content. Therefore, there are cases where even a content to which the client is not compliant with is presented. A non-compliant content is exemplified by the non-compliance of content format, such as video compression format, video resolution, and the like. In this case, from the point of view of the client and user, convenience deteriorates with the presentation of a list which includes contents which cannot be played back on the client. In particular, in the case where many contents are provided from the server, sorting becomes necessary and convenience is greatly reduced.

Furthermore, there are cases where contents requiring a protection technique for copyrights, and the like, are presented to a client that is not equipped with such protection technique, as well as cases where such contents are presented to a client that is not permitted by the right holder. This means that, from the point of view of the client and user, convenience deteriorates with the presentation of a list which includes contents which cannot be played back on the client. In particular, in the case where many contents are provided from the server, sorting becomes necessary and convenience is greatly reduced. Furthermore, from the point of view of the right holder, there is the problem that, presenting the existence of such a content to a user or device which is not permitted increases the threat of unauthorized use of the content.

Moreover, with regard to the content recorded in a DVR, even if the right holder changes the protection condition over the passing of time, such change cannot be reflected in the recorded content. Therefore, even when the need for protection is eliminated, the server is unable to reflect this, and the user's convenience is impaired. On the contrary, in the case where a change is made to require protection, the server is unable to reflect such change, and the rights of the right holder is infringed.

Furthermore, there are cases where a content recorded according to a request of a specific user or client is presented to a party other than such user or client. This could be conceived as a loss of privacy on the part of the user.

In order to solve the conventional problem, the content information outputting apparatus according to the present invention is a content information outputting apparatus which outputs multimedia contents representing at least one of video and audio to a terminal via a network, the content information outputting apparatus including: an application execution unit which executes one or more application programs; a storage unit for storing the multimedia contents; a transmitting and receiving unit which transmits and receives a message to and from the terminal; a message processing unit which processes the message; a content searching unit which searches for a multimedia content falling within a range permitted by a certain application program among one or more of the application programs, from among the multimedia contents stored in the storage unit; and a judgment unit which judges whether or not each of the multimedia contents stored in the storage unit can be outputted, wherein, in the case where the transmitting and receiving unit receives, from the terminal, a request message for transmission of a list of the multimedia contents that can be outputted to the terminal by the content information outputting apparatus: the message processing unit extracts a search condition from the request message received by the transmitting and receiving unit, and passes the extracted search condition to the content searching unit; the content searching unit searches for the multimedia content falling within the range permitted by the application program, based on the received search condition and at least one of an attribute of the multimedia content and an attribute of the terminal; the judgment unit judges, based on at least one of the attribute of the multimedia content and the attribute of the terminal, whether or not the multimedia content searched-out by the content searching unit can be outputted; the message processing unit generates a content list message including information of a list of the multimedia content that is judged by the judgment unit as capable of being outputted, and passes the generated content list message to the transmitting and receiving unit; and the transmitting and receiving unit transmits the content list message to the terminal.

According to the present configuration, the judgment unit enables judgment for whether or not the content can be presented by the terminal or whether or not the content may be presented to the terminal, and thus it becomes possible to transmit the appropriate provided content list conforming to the terminal.

Furthermore, it is also possible that the judgment unit judges whether or not the multimedia content searched-out by the content searching unit can be outputted, based on a judgment condition received from a certain application program among the one or more application programs.

The present configuration enables judgment conditions to be updated by an application program, and thus produces the effect of allowing the flexible performance of judgment condition setting according to various situations such as time and place, the number of reproductions, the partner terminal, and so on. In addition, there is the effect of enabling, even for the same content, the updating of possible/not possible judgment conditions in accordance with the passage of time, the number of reproductions, and so on.

Furthermore, it is also possible that the judgment unit judges whether or not the multimedia content searched-out by the content searching unit can be outputted, by making an inquiry, to an external server, as to whether or not the multimedia content can be outputted. In addition, it is also possible that information identifying the external server is received from a certain application program among the one or more application programs.

The present configuration enables judgment conditions to be updated by an external server, and thus produces the effect of allowing the flexible performance of judgment condition setting according to various situations such as time and place, the number of reproductions, the partner terminal, and so on. In addition, there is the effect of enabling, even for the same content, the updating of possible/not possible judgment conditions in accordance with the passage of time, the number of reproductions, and so on. In addition, through the judgment by an external server, there is the effect of simplifying the packaging of the content information outputting apparatus, and thus enabling the reduction of cost. In addition, through the specification of an external server by the application program, there is the effect of enabling the content provider to specify the external server owned by the provider.

Furthermore, it is also possible that the content information outputting apparatus further includes a broadcast signal receiving unit which receives a broadcast signal including the multimedia content and the one or more application programs.

The present configuration enables the transmission of an appropriate provided content list conforming to the terminal, in the content information outputting apparatus which receives a broadcast signal, and executes an application program, such as a lava application, included in the received broadcast signal.

Furthermore, it is also possible that the search condition is information specifying attributes of the multimedia content, the content searching unit searches for multimedia contents having an attribute specified by the search condition, from among the multimedia contents stored in the storage unit, and, for a multimedia content having an attribute for transmission only to a permitted terminal, among the multimedia contents searched-out by the content searching unit, the judgment unit judges that the multimedia content can be outputted in the case where the terminal has an attribute indicating that receiving of the multimedia content is permitted, and judges that the multimedia content cannot be outputted in the case where the terminal has an attribute indicating that receiving of the multimedia content is not permitted.

Furthermore, the content information receiving apparatus according to the present invention is a content information receiving apparatus which transmits, to a content information outputting apparatus, a request for multimedia content transmission and receives a multimedia content representing at least one of video and audio from the content information outputting apparatus, via a network, the content information receiving apparatus including: an application execution unit which executes one or more application programs; a transmitting and receiving unit which transmits and receives a message to and from the content information outputting apparatus; a message processing unit which processes the message; and a search condition setting unit which sets a search condition, wherein, upon receiving a request from a certain application program among the one or more application programs: the search condition setting unit sets, as the search condition, an attribute of the content information receiving apparatus, and passes the set search condition to the message processing unit; the message processing unit generates a request message for transmission of a list of the multimedia content that can be outputted to the content information receiving apparatus by the content information outputting apparatus, and passes the generated request message to the transmitting and receiving unit, the request message including the received search condition; the transmitting and receiving unit transmits the received request message to the content information outputting apparatus, receives a reply message from the content information outputting apparatus, and passes the received reply message to the message processing unit; and the message processing unit extracts, from the received reply message, the list of the multimedia content that can be outputted to the content information receiving apparatus by the content information outputting apparatus, and passes the extracted content list to the application program.

According to this configuration, through the search condition setting unit, it becomes possible to set and issue more appropriate inquiry conditions conforming to the terminal.

Furthermore, it is also possible that information identifying the content information outputting apparatus with which communication is carried out is received from any application program among the one or more application programs.

Furthermore, it is also possible that a certain application program among the one or more application programs passes a condition to the search condition setting unit, and the search condition setting unit sets the search condition with reference to the received condition.

The present configuration produces the effects of enabling the application program to specify conditions, enabling only the application program permitted by the rights holder to set specific search conditions, and enabling condition setting which allows more appropriate selection by the content information outputting apparatus.

Furthermore, it is also possible that the search condition setting unit makes an inquiry to an external server, and sets the search condition with reference to a condition obtained from the external server. In addition, it is also possible that information identifying the external server is received from a certain application program among the one or more application programs.

The present configuration produces the effect of enabling the setting of search conditions by an external server, and thus enabling search condition setting to be carried out flexibly. In addition, there is the effect of enabling only a terminal permitted by the content provider to set unique search conditions. In addition, through the specification of an external server by the application program, there is the effect of enabling the content provider to specify the external server owned by the provider.

Furthermore, it is also possible that the application program is obtained via a broadcast signal.

The present configuration enables, in the content information receiving unit which receives, via the network, a content from the content information outputting apparatus which receives the broadcast signal, the issuing of a request in which a more appropriate inquiry condition conforming to the content information receiving apparatus is set.

Furthermore, the multimedia content communication system according to the present invention is a multimedia content communication system including: a content information outputting apparatus which outputs multimedia contents representing at least one of video and audio, to a terminal via a network; and a content information receiving apparatus which transmits a request for transmission of multimedia contents to the content information outputting apparatus and receives a multimedia content from the content information outputting apparatus, the content information outputting apparatus and the content information receiving apparatus being connected to the same network, wherein the content information outputting apparatus includes: a first application execution unit which executes one or more application programs; a storage unit for storing the multimedia contents; a first transmitting and receiving unit which transmits and receives a message to and from the content information receiving apparatus; a first message processing unit which processes the message transmitted and received by the first transmitting and receiving unit; a content searching unit which searches for a multimedia content falling within a range permitted by a certain first application program among one or more of the first application programs, from among the multimedia contents stored in the storage unit; and a judgment unit which judges whether or not each of the multimedia contents stored in the storage unit can be outputted, wherein, in the case where the first transmitting and receiving unit receives, from the content information receiving apparatus, a request message for transmission of a list of the multimedia content that can be outputted to the terminal by the content information outputting apparatus: the first message processing unit extracts a search condition from the request message received by the first transmitting and receiving unit, and passes the extracted search condition to the content searching unit; the content searching unit searches for the multimedia content falling within the range permitted by the first application program, based on the received search condition and at least one of an attribute of the multimedia content and an attribute of the terminal; the judgment unit judges, based on at least one of the attribute of the multimedia content and the attribute of the terminal, whether or not the multimedia content searched-out by the content searching unit can be outputted; the first message processing unit generates a content list message including information of a list of the multimedia content that is judged by the judgment unit as capable of being outputted, and passes the generated content list message to the first transmitting and receiving unit; and the first transmitting and receiving unit transmits the content list message to the terminal, the content information receiving apparatus includes: a second application execution unit which executes one or more second application programs; a second transmitting and receiving unit which transmits and receives a message to and from the content information outputting apparatus; a message processing unit which processes the message transmitted and received by the second transmitting and receiving unit; and a search condition setting unit which sets the search condition, wherein, upon receiving a request from a certain second application program among the one or more second application programs: the search condition setting unit sets, as the search condition, an attribute of the content information receiving apparatus, and passes the set search condition to the second message processing unit; the second message processing unit generates the request message including the received search condition, and passes the generated request message to the second transmitting and receiving unit; the second transmitting and receiving unit transmits the received request message to the content information outputting apparatus, receives the content list message from the content information outputting apparatus, and passes the received content list message to the second message processing unit; and the second message processing unit extracts, from the received content list message, the list of the multimedia content that can be outputted to the content information receiving apparatus by the content information outputting apparatus, and passes the extracted content list message to the second application program.

The present configuration enables the setting of appropriate search conditions conforming to the content information receiving apparatus, and enables the content information outputting apparatus to appropriately perform the selection of contents that can be used by in the content information receiving apparatus.

Furthermore, the content information outputting method according to the present invention is a content information outputting method for use in an apparatus which includes a storage unit and an application execution unit, and which outputs multimedia contents stored in the storage unit to a terminal via a network, the storage unit storing the multimedia contents representing at least one of video and audio, the application execution unit executing one or more application programs, the content information outputting method including the following, performed in the case where the apparatus receives, from the terminal, a request message requesting transmission of a list of the multimedia content that can be outputted to the terminal: extracting a search condition from the request message; searching for a multimedia content falling within a range permitted by a certain application program among the one or more application programs, from among the multimedia contents stored in the storage unit, based on the search condition and at least one of an attribute of the content and an attribute of the terminal; judging whether or not the searched-out multimedia content can be outputted, based on at least one of the attribute of the multimedia content and the attribute of the terminal; generating a content list message including information on the multimedia content that is judged as capable of being outputted; and transmitting the content list message to the terminal.

With this, it becomes possible to judge whether or not the content can be used by the terminal, or whether or not the content can be presented to the terminal, and thus it becomes possible to transmit an appropriate provided content list conforming to the terminal.

Furthermore, the content information receiving method according to the present invention is a content information receiving method for use in an apparatus which includes an application execution unit, and which transmits a request for multimedia content transmission to a content information outputting apparatus and receives a multimedia content representing at least one of video and audio, from the content information outputting apparatus via a network, the application execution unit executing one or more application programs, the content information receiving method including the following, performed upon receiving a request from a certain application program among the one or more application programs: setting an attribute of the apparatus as a search condition; generating a request message requesting transmission of a list of the multimedia content that can be outputted to the apparatus by the content information outputting apparatus, the request message including the set search condition; transmitting the request message to the content information outputting apparatus; receiving a reply message from the content information outputting apparatus; and extracting a list of multimedia content that can be outputted to the apparatus by the content information outputting apparatus, and passing the extracted list to the application program.

With this, it becomes possible to issue an inquiry in which a more appropriate inquiry condition conforming to the apparatus is set.

Furthermore, the program for a content information outputting method according to the present invention is a program for a content information outputting method for use in an apparatus which includes a storage unit and an application execution unit, and which outputs multimedia contents stored in the storage unit to a terminal via a network, the storage unit storing the multimedia contents representing at least one of video and audio, the application execution unit executing one or more application programs, the program for the content information outputting method causing a computer to execute the following, in the case where the apparatus receives, from the terminal, a request message requesting transmission of a list of the multimedia content that can be outputted to the terminal: extracting a search condition from the request message; searching for a multimedia content falling within a range permitted by a certain application program among the one or more application programs, from among the multimedia contents stored in the storage unit, based on the search condition and at least one of an attribute of the content and an attribute of the terminal; judging whether or not the searched-out multimedia content can be outputted, based on at least one of the attribute of the multimedia content and the attribute of the terminal; generating a content list message including information on the multimedia content that is judged as capable of being outputted; and transmitting the content list message to the terminal.

Furthermore, the program for a content information receiving method according to the present invention is a program for a content information receiving method for use in an apparatus which includes an application execution unit, and which transmits a request for multimedia content transmission to a content information outputting apparatus and receives a multimedia content representing at least one of video and audio, from the content information outputting apparatus via a network, the application execution unit executing one or more application programs, the program for the content information receiving method causing a computer to execute the following, upon receiving a request from a certain application program among the one or more application programs: setting an attribute of the apparatus as a search condition; generating a request message requesting transmission of a list of the multimedia content that can be outputted to the apparatus by the content information outputting apparatus, the request message including the set search condition; transmitting the request message to the content information outputting apparatus; receiving a reply message from the content information outputting apparatus; and extracting a list of multimedia content that can be outputted to the apparatus by the content information outputting apparatus, and passing the extracted list to the application program.

Note that it goes without saying, such programs can be distributed via a recording medium such as a CD-ROM, and a transmission medium such as the Internet.

As described above, according to the content information outputting apparatus, the content information receiving apparatus, and the multimedia content communication system of the present invention, in an environment in which plural server devices and client devices exist, such as in a home network, it is possible for a server to take into consideration the format of content data, the use rights of contents requiring protection and the like, and contents for which use is limited, and so on, and thus appropriately present a list of usable contents to each client device.

As further information about the technical background to this application, the disclosure of U.S. Provisional Application No. 60/869,632 filed Dec. 12, 2006, including specification, drawings and claims, is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a configuration diagram for the multimedia delivery system in the embodiment of the present invention;

FIG. 2 is a block diagram showing the outline of the functional configuration of the content information outputting apparatus 101 in the embodiment of the present invention;

FIG. 3 is a block diagram showing the outline of the functional configuration of the content information receiving apparatus 102 in the embodiment of the present invention;

FIG. 4 is a diagram showing the flow of operations of the content information outputting apparatus 101 and the content information receiving apparatus 102 in the embodiment of the present invention;

FIG. 5 is a diagram showing an example of the contents 4008 stored in the storage unit 4002 of the present invention;

FIG. 6 is a diagram showing an example of the list of contents outputted by the content information outputting apparatus 101 in the embodiment of the present invention;

FIG. 7 is a diagram showing an example of the list of contents outputted by the content information outputting apparatus 101 in the embodiment of the present invention;

FIG. 8 is a configuration diagram for the content information outputting apparatus 101 in the embodiment of the present invention;

FIG. 9 is a diagram showing an example of an external view in the case where the input 201 unit is made up of a front panel;

FIG. 10 is a structure diagram for the program structure stored in the content information outputting apparatus 101 in the embodiment of the present invention;

FIG. 11A is a diagram showing an example of an on-screen display in the present invention;

FIG. 11B is a diagram showing an example of an on-screen display in the present invention;

FIG. 12 is a diagram showing an example of information stored in the second memory 203 of the present invention;

FIG. 13 is a diagram showing an example of information stored in the second memory 203 of the present invention;

FIG. 14A is a diagram showing an example of information stored in the second memory 203 of the present invention;

FIG. 14B is a diagram showing an example of information stored in the second memory 203 of the present invention;

FIG. 14C is a diagram showing an example of information stored in the second memory 203 of the present invention;

FIG. 15 is a diagram showing an example of information stored in the second memory 203 of the present invention;

FIG. 16 is a diagram showing an example of information stored in the second memory 203 of the present invention;

FIG. 17 is a diagram showing an example of information stored in the second memory 203 of the present invention;

FIG. 18 is a diagram showing an example of information stored in the second memory 203 of the present invention;

FIG. 19 is a diagram showing an example of data stored in the second memory 203 in the embodiment of the present invention;

FIG. 20 is a diagram showing an example of the attribute information of multimedia data in the embodiment of the present invention;

FIG. 21 is a diagram showing an example of the attribute information table in the embodiment of the present invention;

FIG. 22 is a diagram showing an example of the URI table in the embodiment of the present invention;

FIG. 23 is an internal configuration diagram for the network library 405e;

FIG. 24 is a diagram showing an example of a lava API provided in the network library 405e;

FIG. 25 is a diagram showing an example of a Java class definition used in the network library 405e;

FIG. 26 is a diagram showing an example of a Java interface definition used in the network library 405e;

FIG. 27 is a diagram showing an example of a Java class definition used in the network library 405e;

FIG. 28 is a diagram showing an example of a Java class definition used in the network library 405e;

FIG. 29 is a diagram showing an example of a Java API provided in the network library 405e;

FIG. 30 is a diagram showing an example of a Java API provided in the network library 405e;

FIG. 31 is a diagram showing an example of a Java class definition used in the network library 405e;

FIG. 32 is a diagram showing an example of a Java API provided in the network library 405e;

FIG. 33 is a diagram showing an example of a Java API provided in the network library 405e;

FIG. 34 is a diagram showing an example of a Java class definition used in the network library 405e;

FIG. 35 is a configuration diagram for the content information receiving apparatus 102 in the embodiment of the present invention;

FIG. 36 is a structure diagram for the program structure stored in the content information receiving apparatus 102 in the embodiment;

FIG. 37 is an internal configuration diagram for the network library 3004d;

FIG. 38 is a diagram showing an example of a Java API provided in the network library 3004d;

FIG. 39 is a diagram showing an example of a Java class definition used in the network library 3004d;

FIG. 40 is a diagram showing an example of a lava class definition used in the network library 3004d;

FIG. 41 is a diagram showing an example of a Java class definition used in the network library 3004d;

FIG. 42 is a diagram showing an example of a Java API provided in the network library 3004d;

FIG. 43 is a diagram showing an example of a Java API provided in the network library 3004d;

FIG. 44 is a diagram showing an example of a Java API provided in the network library 3004d; and

FIG. 45 is a diagram showing an example of a Java API provided in the network library 3004d.

### DESCRIPTION OF THE PREFERRED EMBODIMENT(S)

Hereinafter, the embodiment of the present invention shall be described with reference to the drawings.

### Embodiment

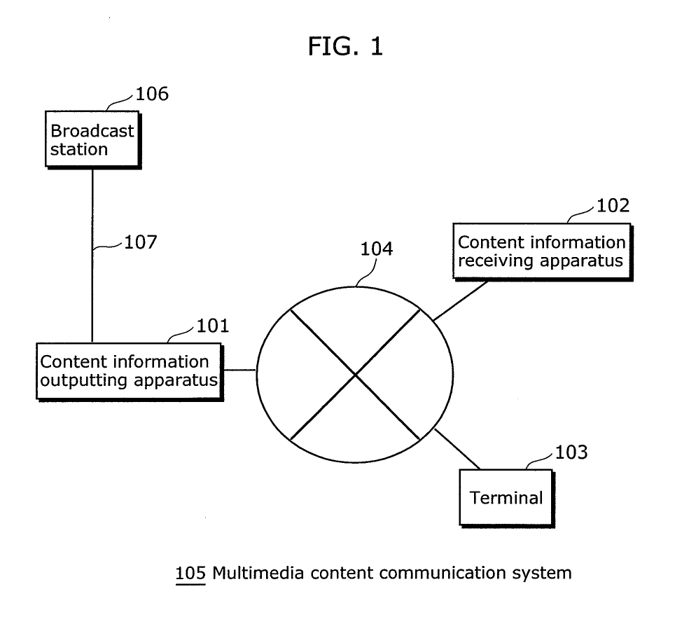

FIG. 1 is a configuration diagram for the multimedia content communication system in the embodiment of the present invention. In FIG. 1, 101 denotes a content information outputting apparatus in the present invention, 102 denotes a content information receiving apparatus in the present invention, 103 denotes a terminal which is a general client device, 104 denotes a network, and 105 denotes a multimedia content communication system made up of these elements. The content information outputting apparatus 101, the content information receiving apparatus 102, and the terminal 103 are connected to the network 104 (for example, a home network), and can mutually communicate with a useable apparatus (the content information outputting apparatus 101, the content information receiving apparatus 102, and the terminal 103 in this example) via the network 104. In addition, 106 denotes a cable television broadcast station, 107 denotes a cable connecting the content information outputting apparatus 101 and the broadcast station 106.

The content information outputting apparatus 101 in the present embodiment is a CATV Set Top Box (STB) which includes a network interface and a storage unit for storing multimedia data, and which receives a digital broadcast. The content information outputting apparatus 107 is connected to the broadcast station 106 via the cable 107. In addition, the content information outputting apparatus 101 stores the multimedia data of a digital broadcast content received from the broadcast station 106, in the storage unit. Furthermore, the content information outputting apparatus 101 is connected to the network 104 via the network interface. In addition, it receives requests transmitted, through the network 104, from the content information receiving apparatus 102 and the terminal 103. Subsequently, in accordance with the requests, the content information outputting apparatus 101 transmits, to the content information receiving apparatus 102 and the terminal 103, through the network 104, the information and attributes or the multimedia data of the contents of digital broadcasts received, or each of the stored contents. Note that although in the present embodiment, Hypertext Transfer Protocol (HTTP), which is a mandatory protocol in the DLNA, is used as the communication protocol used when the content information outputting apparatus 101 outputs multimedia data via the network 104, the same effect can be achieved even with other protocols.

Moreover, the digital broadcast content stored by the content information outputting apparatus 101 in the storage unit is data in the MPEG2-TS format. Broadcast contents include contents for which use is limited by the content holder or broadcast operator according to the purpose of its copyright protection, as well as contents that can be used without any special limitation. The former shall be called a protected video content and the latter shall be called a general video content. The content information outputting apparatus 101 can recognize whether a content is a protected video content or a general video content, from information included in a notification or content data broadcasted from the broadcast station 106.

Aside from this, the content information outputting apparatus 101 stores, in the storage unit, images in the JPEG format and music in the MP3 format. Image data and music data are either received and stored as data included in broadcast data or stored via the network 104, a storage medium such as an optical disc or memory card, and so on. In addition, such video, image, and music data are provided to the content information receiving apparatus 102 and the terminal 103. Note that the content information outputting apparatus 101 may provide all multimedia contents stored in the storage unit, and may also provide multimedia contents within the scope set according to an application downloaded from the broadcast station.

The content information outputting apparatus 101 defines the media class derivative class defined in UPnP for each of these contents, then associates, and stores the contents. For a protected video content, a derivative class of object.item.videoItem. protectedTSVideo of the object.item.videoItem class is associated. For a general video content, a derivative class of object.item.videoItem.TSVideo of the object.item.videoItem class is associated. For an image in the JPEG format, a derivative class of object.item.imageItem.JPEG of the object.item.videoItem class is associated. For music in the MP3 format, a derivative class of object.item.audioItem.MP3 of the object.item.videoItem class is associated.

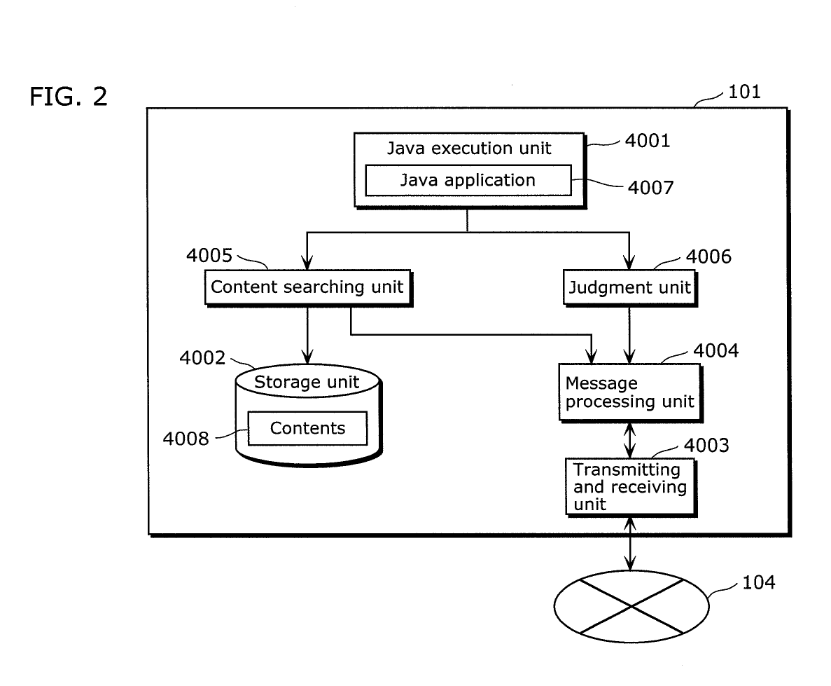

FIG. 2 is a block diagram showing the outline of the functional configuration of the content information outputting apparatus 101 in the present embodiment.

The content information outputting unit 101 outputs a multimedia content representing at least one of video or audio, to the content information receiving apparatus 102 and the terminal 103, via the network 104. The content information outputting unit 101 includes a Java execution unit 4001, a storage unit 4002, a transmitting and receiving unit 4003, a message processing unit 4004, a content searching unit 4005, and a judgment unit 4006.

The Java execution unit executes a Java application 4007. The Java application 4007 is obtained by the content information outputting apparatus 101 from the broadcast station via a broadcast signal or the Internet.

The storage unit 4002 stores the data of multimedia contents 4008.

The transmitting and receiving unit 4003 transmits and receives messages between the content information receiving unit 102 and the terminal 103 which are connected to the network 104. More specifically, the transmitting and receiving unit 4003 receives a list transmission request message from the content information receiving apparatus 102 and the terminal 103. The list transmission message is a message requesting the transmission of a list of contents that can be outputted by the content information outputting apparatus 101 to the content information receiving apparatus 102 or the terminal 103.

Furthermore, the transmitting and receiving unit 4003 sends back, to the content information receiving apparatus 102 and the terminal 103, a content list message which is a reply message responding to the list transmission request message.

The message processing unit 4004 processes the messages transmitted and received by the transmitting and receiving unit 4003. More specifically, the message processing unit 4004 extracts search conditions from the list transmission request message received by the transmitting and receiving unit 4003, and passes this to the content searching unit 4005. A search condition is information specifying the attribute of a content and, more specifically, is information showing the media format that can be reproduced by the content information receiving apparatus 102, or the terminal 103, which is the transmission sources of the list transmission request message.

Furthermore, the message processing unit 4004 generates a content list message including information of the list of contents that can be outputted according to the judgment of the judgment unit 4006, and passes the content list message to the transmitting and receiving unit 4003.

The content searching unit 4005 searches for a content falling within a range permitted by the Java application 4007 executed by the Java execution unit 4001, from among the contents 4008 stored in the storage unit 4002. Specifically, the content searching unit 4005 searches for a content falling within the range permitted by the Java application 4007, based on the search condition received from the message processing unit 4004 and at least one of the attribute of the content, and the attribute of the content information receiving apparatus 102 or the terminal 103. More specifically, the content searching unit 4005 searches for a content having an attribute specified by the search conditions, from among the contents 4008 stored in the storage unit 4002.

The judgment unit 4006 judges whether or not each of the contents 4008 stored in the storage unit 4002 can be outputted. Specifically, the judgment unit 4006 judges whether or not each of the contents searched-out by the content searching unit 4005 can be outputted based on at least one of the attribute of the content and the attribute of the content information receiving unit 102 or the terminal 103.

More specifically, with respect to a content having an attribute allowing transmission only to a permitted terminal, that is, a content requiring protection, among the contents searched-out by the content searching unit 4005, the judgment unit 4006 judges that the content can be outputted in the case where the content information receiving apparatus 102, or the terminal 103, which is the transmission sources of the list transmission request message, has an attribute permitting the reception of the content, and judges that the content cannot be outputted in the case where the content information receiving apparatus 102 or the terminal 103 has an attribute which does not permit the reception of the content. Furthermore, the judgment unit 4006 judges that outputting is possible for a content that does not require protection, among the contents searched-out by the content searching unit 4005.

Note that the judgment unit 4006 may also judge whether or not the multimedia contents searched-out by the content searching unit 4005 can be outputted, based on the judgment conditions received from the lava application 4007. Furthermore, by making an inquiry, to an external server, as to whether or not outputting of multimedia content is possible, the judgment unit 4006 may obtain a judgment result or judgment conditions, and judge whether or not the multimedia contents searched-out by the content searching unit 4005 can be outputted.

The content information receiving apparatus 102 transmits a transmission request for a list of contents that can be provided, and a transmission request for the multimedia and content attribute, to the content information outputting apparatus 101 according to a user's request. Furthermore, as a reply to the request, the content information receiving apparatus 102 receives data from the content information outputting apparatus 101 and presents the data to the user. Note that it is assumed that the content format to which the content information receiving apparatus 102 is compliant, are MPEG2-TS formatted video and JPEG formatted images. Moreover, it is assumed that the content information receiving apparatus 102 is a terminal for which the use of protected video content is allowed by the content right holder or the broadcast station 106. Therefore, the content information receiving apparatus 102 can use both protected video contents and general video contents.

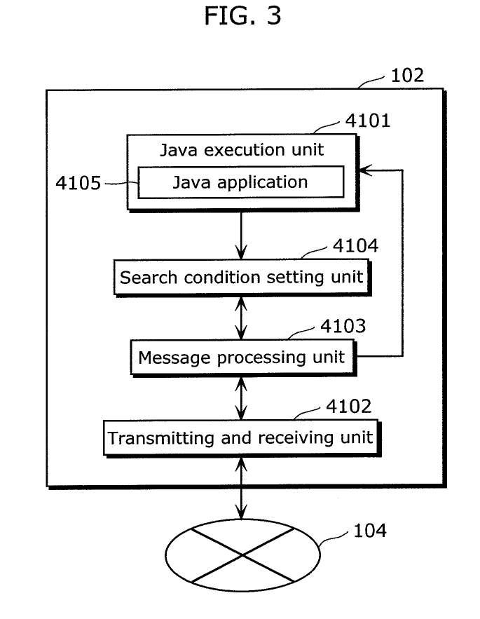

FIG. 3 is a block diagram showing the outline of the functional configuration of the content information receiving apparatus 102.

The content information receiving apparatus 102 transmits, to the content information outputting apparatus 101, a request for multimedia content transmission. The content information receiving apparatus 102 receives content data transmitted from the content information outputting apparatus 101 in response to the transmitted request. The content information receiving apparatus 102 includes a Java execution unit 4101, a transmitting and receiving unit 4102, a message processing unit 4103, and a search condition setting unit 4104.

The Java execution unit 4101 executes a Java application 4105. For example, the Java application 4105 is obtained by the content information receiving apparatus 102 from the broadcast station via a broadcast signal or the Internet. Furthermore, the content information receiving apparatus 102 may also obtain the Java application 4105 from the content information outputting apparatus 101, via the network 104.

The transmitting and receiving unit 4102 transmits and receives messages between the content information outputting apparatus 101, via the network 104. More specifically, the transmitting and receiving unit 4102 transmits the list transmission request message received from the message processing unit 4103, to the content information outputting apparatus 101. Furthermore, the transmitting and receiving unit 4102 receives a content list message, which is a reply message from the content information outputting apparatus 101, and passes this to the message processing unit 4103.

The message processing unit 4103 processes messages transmitted from the transmitting and receiving unit 4102. More specifically, the message processing unit 4103 generates, based on the search conditions received from the search condition setting unit 4104, a list transmission request message for contents, to be transmitted to the content information outputting apparatus 101, and passes this to the transmitting and receiving unit 4102. In other words, the message processing unit 4103 generates a list transmission request including the search conditions received from the search condition setting unit 4104.

Furthermore, the message processing unit 4103 extracts a content list from the content list message received from the transmitting and receiving unit 4102, and passes this to the java execution unit 4101.

The search condition setting unit 4104 sets search conditions to be requested to the content information outputting apparatus 101, upon receiving a request from the lava execution unit 4101. More specifically, the search condition setting unit 4104 sets the attribute of the content information receiving apparatus 102, as the search conditions, and passes the set search conditions to the message processing unit 4103.

The terminal 103 transmits a transmission request for a list of contents that can be provided, and a transmission request for the multimedia and content attribute, to the content information outputting apparatus 101 according to a user's request. Furthermore, as a reply to the request, the content information receiving apparatus 102 receives data from the content information outputting apparatus 101 and presents the data to the user. The terminal 103 is a device that is not equipped with the search condition setting unit 4104 included in the content information receiving apparatus 102 of the present invention, as in a device implemented according to the DLNA laid-out guidelines, for example. Since details of DLNA-compliant devices are described in the guidelines issued by the DLNA, their description shall be omitted. Note that it is assumed that the content format to which the terminal 103 is compliant, are MPEG2-TS formatted video, MPEG2-PS formatted video, JPEG formatted images, and MP3 formatted music. Moreover, it is assumed that the terminal 103 is a terminal for which the use of protected video content is not allowed by the content right holder or the broadcast station 106. Therefore, the terminal 103 is compliant only to general video contents and cannot use protected video contents.

The network 104 is a home network established in the household, and is an IP network configured of the Internet, wireless LAN, and so on.

Hereinafter, the communication between the content information outputting apparatus 101 and the content information receiving apparatus 102, terminal 103, and their respective operations shall be described.

When connected to the network 104, the content information outputting apparatus 101, the content information receiving apparatus 102, and the terminal 103 search for other apparatuses which are connected to the network 104 so as to obtain what functions each apparatus has. Since this communication is carried out according to a method defined by the UPnP Device Architecture (DA), in the same manner as with DLNA, detailed description shall be omitted. With this, the content information outputting apparatus 101 can recognize that the content information receiving apparatus 102 and the terminal 103 are players connected to the network 104, and which receive multimedia data from the network 104 and reproduce such received multimedia data. Furthermore, the content information receiving apparatus 102 and the terminal 103 can recognize that the content information outputting apparatus 101 is a multimedia server connected to the network 104.

Hereinafter, the communication between the content information outputting apparatus 101 and the content information receiving apparatus 102 shall be described.

First, the content information receiving apparatus 102 issues a transmission request for a list of contents that can be provided, to the content information outputting apparatus 101. Subsequently, upon receiving the request, the content information outputting apparatus 101 searches for the contents that can be provided, and replies to the content information receiving apparatus 102, with the list. This communication can be carried out using the Browse or Search in the UPnP AV Content Directory Service (CDS), and thus detailed description shall be omitted.

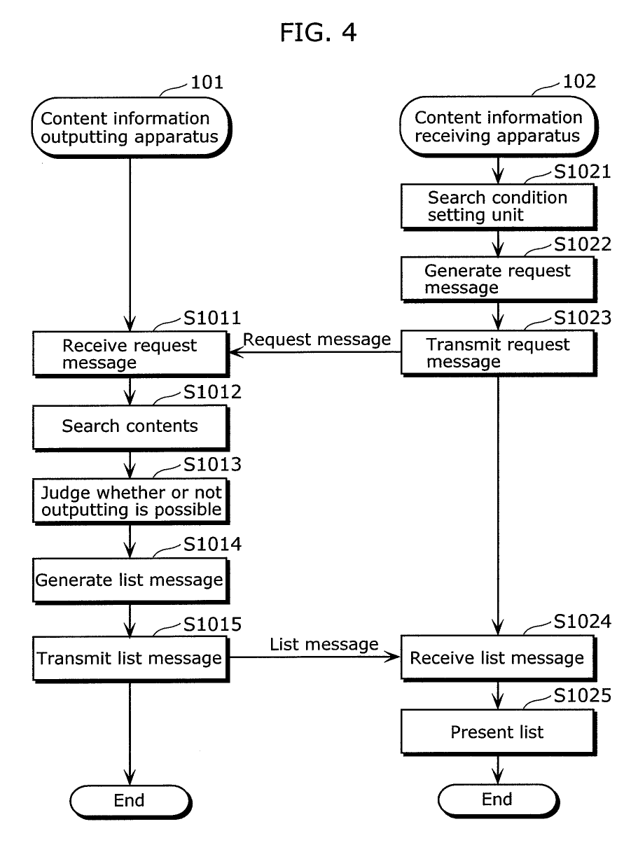

FIG. 4 is a diagram showing the flow of operations of the content information outputting apparatus 101 and the content information receiving apparatus 102.

When issuing, to the content information outputting apparatus 101, a transmission request for a list of contents that can be provided, the content information receiving apparatus 102 sets the search condition to be requested to the content information outputting apparatus 101 based on its own attributes (S1021), and generates a content list transmission request message (S1022). The content information receiving apparatus 102 transmits the generated content list transmission request message to the content information outputting apparatus 101 (S1023).

In the present embodiment, the attributes of the content information receiving apparatus 102 are assumed to be the compliant formats and the presence/absence of a right to use a prohibited video content. This search condition is set in a Search request and transmitted. Properties expanded from the UPnP and DLNA are used for the property of the request. For the compliant formats, the object.item.videoItem.protectedTSVideo class indicating a protected video content, object.item.videoItem. TSVideo class indicating a general video content, and object.item.imageItem.JPEG class indicating a JPEG-formatted image are set in the Search request, as the property referred to as upnp:class, and transmitted. Furthermore, since the content information receiving apparatus 102 has obtained permission to use protected video contents, this is included in the Search request and transmitted. In the present embodiment, it is assumed that an identifier id of the content information receiving apparatus 102 issued by the broadcast station 106 or the content right holder is transmitted. This can be transmitted by adding a unique extension tag to a SOAP message configured of XML to be sent as the Search request. Note that transmission may also be performed by transmitting the aforementioned object.video.videoItem. protectedTSVideo, and may also be shown by adding a unique extension tag to a SOAP message configured of XML to be sent as the Search request. Furthermore, it is also possible to attach a digital certificate issued by the broadcast station 106 or the content right holder.

Upon receiving the list transmission request for the contents that can be provided, from the content information receiving apparatus 102, the content information outputting apparatus 101 selects, from among the contents 4008 stored in the storage unit 4002, only the contents that can be used in the content information receiving apparatus 102, and replies with a list thereof. When the aforementioned content list transmission request is received (S1011), the content information outputting apparatus 101 first picks out, from among the contents stored in the storage unit 4002 and that are allowed to be provided via the network, contents complying with the media format specified in the above-described search condition (S1012). Next, each one of the contents is judged as to whether or not it can be transmitted to the content information receiving apparatus 102 (S1013). This is judged according to whether or not the transmission-destination terminal has the processing right for protected video contents. Therefore, contents other than protected video contents are judged as transmittable. Furthermore, since the fact that the content information receiving apparatus 102 has obtained the right to use protected video contents is known from the inclusion of the identifier id in the aforementioned search condition, the protected video contents are also judged as transmittable.

The content information outputting apparatus 101 performs the judgment for all the contents that are picked out, and generates a list of only the transmittable contents (S1014), and transmits the generated list to the content information receiving apparatus 102 (S1015). Since a list defined by the UPnP AV or DLNA can be used for the list to be transmitted, detailed description shall be omitted. In this case, the content information outputting apparatus 101 transmits, from among contents that are allowed to be provided via the network, a list of the protected video contents, general video contents, and JPEG-formatted images to the content information receiving apparatus 102.

Note that in order for the content information outputting apparatus 101 to check whether the content information receiving apparatus 102 has obtained the use right for the protected video contents, certification of the content information receiving apparatus 102 may be carried out. Alternatively, it is also possible to communicate with the broadcast station 106 or an external server which is not illustrated, transmit the identifier id, and carry out verification.

With this, information of contents that cannot be used in the content information receiving apparatus 102 is not transmitted from the content information outputting apparatus 101.

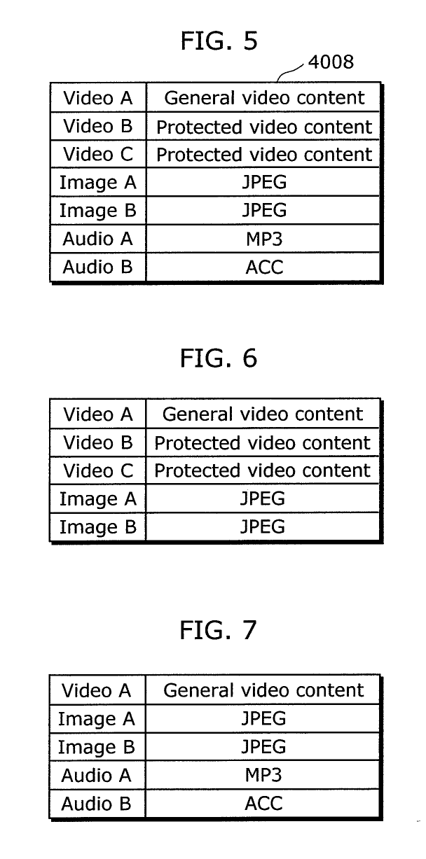

FIG. 5 is a diagram showing and example of the contents 4008 stored in the storage unit 4002 of the content information outputting unit 101. For example, as shown in FIG. 5, the contents 4008 includes video A which is a general video content, video B and video C which are protected video contents, image A and image B which are in the JPEG format, audio A which is in the MP3 format, and audio B which is in the AAC format.

FIG. 6 is a diagram showing an example of a provided content list transmitted from the content information outputting apparatus 101 to the content information receiving apparatus 102. In the case where the contents 4008 shown in FIG. 5 are stored in the storage unit 4002, the provided content list includes, as shown in FIG. 6, the video A which is a general video content, the video B and the video C which are protected video contents, and the image A and the image B which are in the JPEG format, which can be used in the content information receiving unit 102. Furthermore, the provided content list does not include the audio A and the audio B which are in the MP3 format and the AAC format which cannot be used by the content information receiving apparatus 102.

Receiving the provided content list (S1024), the content information receiving apparatus 102 presents this list to the user (S1025). Then, content information receiving apparatus 102 requests the data transmission for the content selected by the user, to the content information outputting apparatus 101. The content information outputting apparatus 101 reads the requested content data from the storage unit 4002, and transmits this to the content information receiving apparatus 102. Receiving the content data, the content information receiving apparatus 102 displays this to the user. Since this series of operations can be carried out using a method defined by the DLNA, detailed description shall be omitted.

Hereinafter, the communication between the content information outputting apparatus 101 and the terminal 103 shall be described.

First, as in the case of the content information receiving apparatus 102, the terminal 103 issues a transmission request for a list of contents that can be provided, to the content information outputting apparatus 101. Subsequently, upon receiving the request, the content information outputting apparatus 101 searches for the contents that can be provided, and replies to the terminal 103, with the list. This communication can be carried out using the Browse or Search in the UPnP AV CDS, and thus detailed description shall be omitted.

However, since the terminal 103 is a device defined by the DLNA, search including the derivative class is requested, using object.item.videoItem, object.item.imageItem, and object.item. audioItem as the upnp:class property of the Search request. Furthermore, since permission to use protected video contents has not been obtained, information thereof cannot be included.

Upon receiving the Search request from the terminal 103, the content information outputting apparatus 101 searches for the contents in accordance with the request from the terminal 103, in the same manner as when partnered with the content information receiving apparatus 102. Then, it judges whether or not the picked-out contents can be provided, and replies to the terminal 103 with a list of only the contents that are judged as those that can be provided.

First, a search for contents is carried out according to the property set in the Search request, from among contents that are allowed to be provided via the network among the contents stored in the storage unit 4002. In this case, since object.item.videoItem. ProtectedTSVideo and object.item.videoItem.TSVideo are both derivative classes of object.item.videoItem, and object.item. imageItem.JPEG is a derivative class of object.item.imageItem, and object.item.audioItem.MP3 is a derivative class of object.item. audioItem, all contents that are allowed to be provided via the network are picked out. Next, each one of the contents is judged as to whether or not it can be transmitted to the terminal 103. This is judged according to whether or not the terminal 103 has the processing right for protected video contents. Therefore, contents other than protected video contents are judged as transmittable, and protected video contents are judged as not transmittable.

With these processes, the content information outputting apparatus 101 transmits, from among contents that are allowed to be provided via the network, a list of the protected video contents, general video contents, and JPEG-formatted images to the terminal 103.

Receiving the provided content list, the terminal 103 presents this list to the user, in the same manner as the content information receiving apparatus 102. Then, the terminal 103 requests the data transmission for the content selected by the user, to the content information outputting apparatus 101. The content information outputting apparatus 101 reads the requested content data from the storage unit 4002, and transmits this to the content information receiving apparatus 102. Upon receiving the content data, the terminal 103 displays this to the user. Since this series of operations can be carried out using a method defined by the DLNA, detailed description shall be omitted.

In such manner, the content information outputting apparatus 101 presents protected video contents to the content information receiving apparatus 102 for which use thereof is permitted, and does not present protected video contents to the terminal 103 for which use is not permitted. Therefore, the terminal 103 cannot detect the fact that a protected video content is stored in the content information outputting apparatus 101, and thus unauthorized use can be prevented.

FIG. 7 is a diagram showing an example of the provided content list transmitted from the content information outputting apparatus 101 to the terminal 103. In the case where the contents 4008 shown in FIG. 5 are stored in the storage unit 4002, the provided content list includes, as shown in FIG. 7, the video A which is a general video content, the image A and the image B which are in the JPEG format, and the audio A which is in the MP3 format, which can be used in the terminal 103. Furthermore, the provided content list does not include the video A and the video B which are protected video contents that cannot be used by the terminal 103.

Furthermore, with the terminal 103, there is no guarantee that only usable contents are presented. For example, consider the case where the content information outputting apparatus 101 stores and provides, in addition, music in the AAC format, and the terminal 103 is not compliant with the AAC format. In addition, the content information outputting apparatus 101 stores, in association, a derivative class of object.item.audioItem.AAC of the object.item.audioItem, for music in the AAC format. In this case, the content information outputting apparatus 101 replies to the content list transmission request from the terminal 103 with a list including music in the AAC format. Therefore, unusable AAC-formatted music is presented in the terminal 103. For example, as shown in FIG. 7, audio B which is in the AAC format is included in the list.

However, in the content information receiving apparatus 102, music in the MP3 format and the AAC format to which it is not compliant is not presented, and only contents that can be surely used are presented. With this, only useable contents are presented to the user of the content information receiving apparatus 102, and thus convenience is improved.

Hereinafter, the content information outputting apparatus 101 and the content information receiving apparatus 102 included in the multimedia content communication system 105 of the present invention shall be described in more detail.

First, the content information outputting apparatus 101 shall be described.

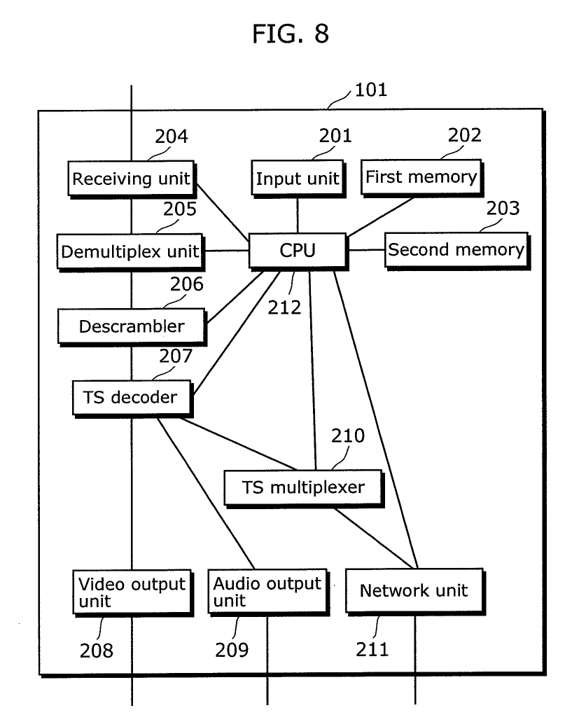

FIG. 8 is a block diagram showing the relationship of constituent elements making up the content information outputting apparatus 101 in the present embodiment. The content information outputting apparatus 101 includes an input unit 201, a first memory 202, a second memory 203, a receiving unit 204, a demultiplex unit 205, a descrambler 206, a TS decoder 207, a video output unit 208, an audio output unit 209, a TS multiplexer 210, a network unit 211, and a CPU 212.

Note that the functions of the lava execution unit 4001, the transmitting and receiving unit 4003, the message processing unit 4004, the content searching unit 4005, and the judgment unit 4006 shown in FIG. 2 are implemented through the execution, by the CPU 212, of a program stored in the second memory 203. Furthermore, the storage unit 4002 is implemented through the second memory 203.

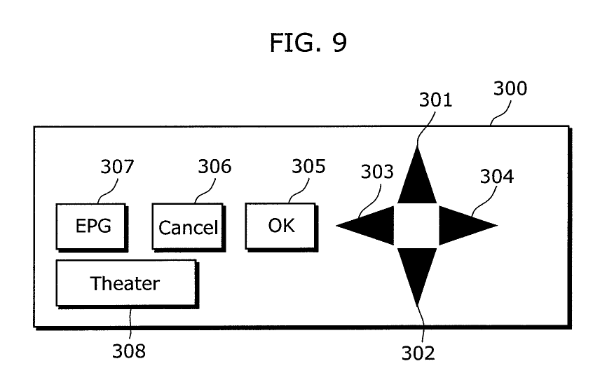

The input unit 201 is configured of a front panel, remote control light receiver, and the like, and accepts a channel selection from a user. FIG. 9 shows an example of the input unit 201 in the case where it is configured of a front panel. 300 is a front panel configured of 8 buttons, namely, an up-cursor button 301, a down-cursor button 302, a left-cursor button 303, a right-cursor button 304, an OK button 305, a cancel button 306, an EPG button 307, and a theater button 308. When the user presses down a button, the identifier of such pressed button is notified to the CPU 212.

The first memory 202 is configured of a RAM, or the like, and is used when the CPU 212 temporarily stores data.

The second memory 203 is configured of a device that can hold information even when power is turned off, such as a flash memory, a hard disk, or the like, and stores a program executed by the CPU 212. For the second memory, a detachable storage device such as an SD memory card and the like may also be used.

The receiving unit 204 is connected to the cable from a CATV station from which it receives broadcast signals. The receiving unit 204 tunes to the frequency specified by the CPU 212, extracts an MPEG transport stream and passes this to the demultiplex unit 205.

The demultiplex unit 205 receives the MPEG transport stream from the receiving unit 204, extracts information specified by the CPU 212 and passes it to the CPU 212. In addition, it passes the MPEG transport stream directly to the descrambler 206.

The descrambler 206 descrambles (=decrypts) the scrambled MPEG transport stream provided by the demultiplex unit 205, and passes this to the TS decoder 207. Furthermore, the descrambler 206 also performs the role of extracting information on whether protection is necessary/unnecessary for a TV-program, which is included in the MPEG transport stream, and passing this to the CPU 212. The descrambler 206 may be a module built-into the content information outputting apparatus 101, and may also be implemented through the CableCARD™ introduced in North American cable receivers. The specifications of CableCARD is described in the CableCARD Interface Specification laid out by the North American CableLabs.

The TS decoder 207 receives identifiers of section data such as audio data, video data, PSI/SI information, and so on, from the CPU 212. In addition, the TS decoder 207 extracts, from the descrambled stream received from the descrambler 206, data corresponding to the received identifiers of section data such as audio data, video data, PSI/SI information, and so on, and passes the extracted video data to the video output unit 208, and the audio data to the audio output unit 209. Furthermore, the TS decoder 207 passes both the video data and the audio data, as well as the section data to the TS multiplexer 210.

The video output unit 208, which includes a video output terminal, converts the received video data to video data that complies with the terminal and outputs this. An example of the terminal is a composite cable terminal, and so on.

The audio output unit 209, which includes an audio output terminal, converts the received video data to video data that complies with the terminal and outputs this. Examples of the terminal are earphone terminals, a composite cable terminal, and so on.

The TS multiplexer 210 configures an MPEG2 transport stream from the received video data, audio data, and section data, and passes the MPEG2 transport stream to the network unit 211. The PSI/SI information can be rewritten as necessary.

The network unit 211, which includes a network interface, converts the data received from the CPU 212 into a signal that is in accordance with the physical media of the network to which the network interface is connected to, and outputs this signal. Furthermore, the network unit 211 receives a signal from the network interface, converts the signal into a packet defined by the IP network, and passes the packet to the CPU 212.

The CPU 212 controls the receiving unit 204, the demultiplex unit 205, the descrambler 206, the TS decoder 207, the TS multiplexer 210, and the network unit 211 by executing a program stored in the second memory 203.

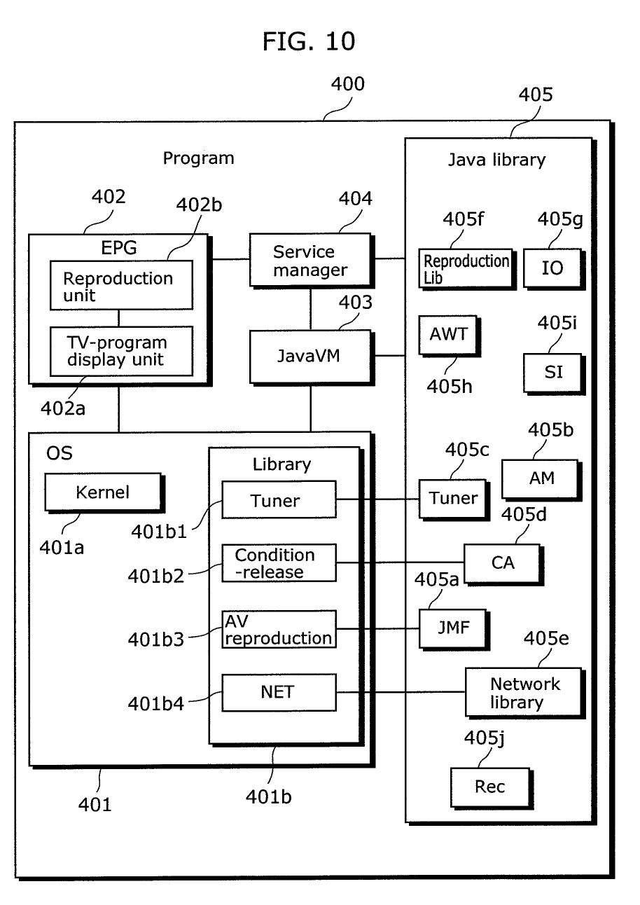

FIG. 10 is an example of a structure diagram of the program stored in the second memory 203 and executed by the CPU 212.

A program 400 is made up of plural subprograms, and is specifically made up of an OS 401 an EPG 402, a lava VM 403, a service manager 404, and a Java library 405.

The OS 401 is a subprogram activated by the CPU 212 when power to the content information outputting apparatus 101 is turned on. OS stands for operating system, an example of which is Linux and the like. The OS 401 is a generic name for publicly known technology made up of a kernel 401a for executing a subprogram concurrently with another subprogram and of a library 401b, and therefore detailed description is omitted. In the present embodiment, the kernel 401a of the OS 401 executes the EPG 402 and the VM 403 as subprograms. Furthermore, the library 401b provides these subprograms with plural functions required for controlling the constituent elements held by the content information outputting apparatus 101.

In the present embodiment, the library 401b includes a tuner 401b1, condition-release 201b2, AV reproduction 401b3, and NET 401b4, as an example of functions.

The tuner 401b1 receives tuning information including a frequency from other subprograms and a Tuner 405c of the Java library 405, and passes this to the receiving unit 204. The receiving unit can perform demodulation based on the provided tuning information, and pass the demodulated data to the demultiplex unit 205. As a result, the other subprograms and the Tuner 405c of the Java library 405 can control the receiving unit 204 through the library 401b.

The condition-release 401b2 receives information from other subprograms and a CA 405d of the Java library 405, and passes this to the descrambler 206.

The AV reproduction 401b3 receives the audio packet ID and video packet ID from the other subprograms and a JMF 405a of the Java library 405. It then provides the received audio packet ID and video packet ID to the TS decoder 207. As a result, the TS decoder 109 performs filtering based on the provided packet IDs, and implements the reproduction of audio/video.

The NET 401b4 creates packets of a protocol lower than the application level defined by the IP network, for the data received from the other subprograms and a network library 405e of the Java library 405. A protocol lower than the application level refers to, for example, a TCP packet, a UDP packet, an IP packet, and so on. By passing this to the network unit 211, messages and data are transmitted to another device via the network 104. Furthermore, when a message is received from another device via the network 104, the NET 401b4 converts the message to an application level protocol packet and passes this to the other subprograms and the network library 405e of the Java library 405. An application level protocol refers to, for example, HTTP, Real-time Transport Protocol (RTP), and so on.

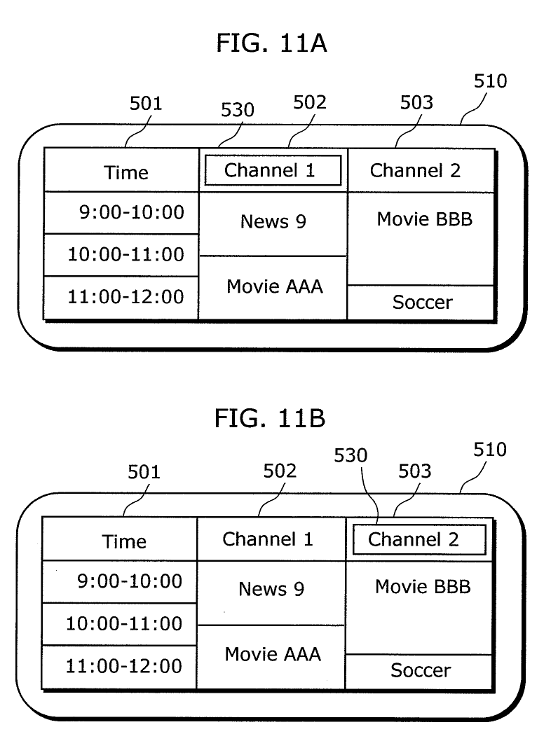

The EPG 402 is made up of a TV-program display unit 402a for displaying a list of TV-programs to the user as well as for accepting an input from the user, and a reproduction unit 402b for selecting channels. Here, EPG is an abbreviation of Electric Program Guide. The EPG 402 is activated by the kernel 401a when power to the content information outputting apparatus 101 is turned on. Inside the activated EPG 402, the TV-program display unit 402a and the reproduction unit 402b are activated at the same time. When activated, the TV-program display unit 402a waits for an input from the user through the input unit 201 of the content information outputting apparatus 101. Here, in the case where the input unit 201 is configured of a front panel as shown in FIG. 9, when the user presses down the EPG button 307 of the input unit 201, the identifier of such EPG button is notified to the CPU 212. The TV-program display unit 402a of the EPG 402, which is a subprogram running on the CPU 212, accepts this identifier, then creates TV-program information display data, and displays this on a monitor 510 using a monitor output unit that is not shown in the figure. The monitor 510 may be included in the content information outputting apparatus 101, and may also be a television connected to the content information outputting apparatus 101 by a composite cable, HDMI cable, or the like. The monitor 510 displays the received TV-program information display data. FIG. 11A and FIG. 11B are examples of a TV-program list displayed on the monitor 510. Referring to FIG. 11B, TV-program information is displayed on the monitor 510 in a grid pattern. A column 501 displays time information. A column 502 displays a channel name “Channel 1” and TV-programs to be broadcast during time periods corresponding to the respective times described in the column 501. The monitor 510 shows that, on “Channel 1”, a TV-program “News 9” is broadcast from 9:00 to 10:30, and “Movie AAA” is broadcast from 10:30 to 12:00. As in the case of the column 502, a column 503 displays a channel name “Channel 2” and TV shows to be broadcast during time periods corresponding to the respective times described in the column 501. A TV show “Movie BBB” is broadcast from 9:00 to 11:00, and “News 11” is broadcast from 11:00 to 12:00. 530 is a cursor. The cursor 530 moves at the press of the left-cursor 303 or the right-cursor 304 on the front panel 300. When the right-cursor 304 is pressed down in the state illustrated in FIG. 11A the cursor 530 moves towards the right as shown in FIG. 11B. Furthermore, when the left-cursor 303 is pressed down in the state illustrated in FIG. 11B the cursor 530 moves towards the left as shown in FIG. 11A.

When the OK button 305 on the front panel 300 is pressed down in the state shown in FIG. 11A, the TV-program display unit 402a notifies the reproduction unit 402b of the identifier of the “Channel 1”. When the OK button 305 on the front panel 300 is pressed down in the state shown in FIG. 11B, the TV-program display unit 402a notifies the reproduction unit 402b of the identifier of the “Channel 2”.

Furthermore, through the demultiplex unit 205, the TV-program display unit 402a regularly stores in advance, in the second memory 203, TV-program information to be displayed. Generally, it takes time to obtain TV-program information from the broadcast station. It is possible to quickly display a TV-program table by displaying the TV-program information, previously stored in the second memory 203, at the press of the EPG button 307 of the input unit 201.

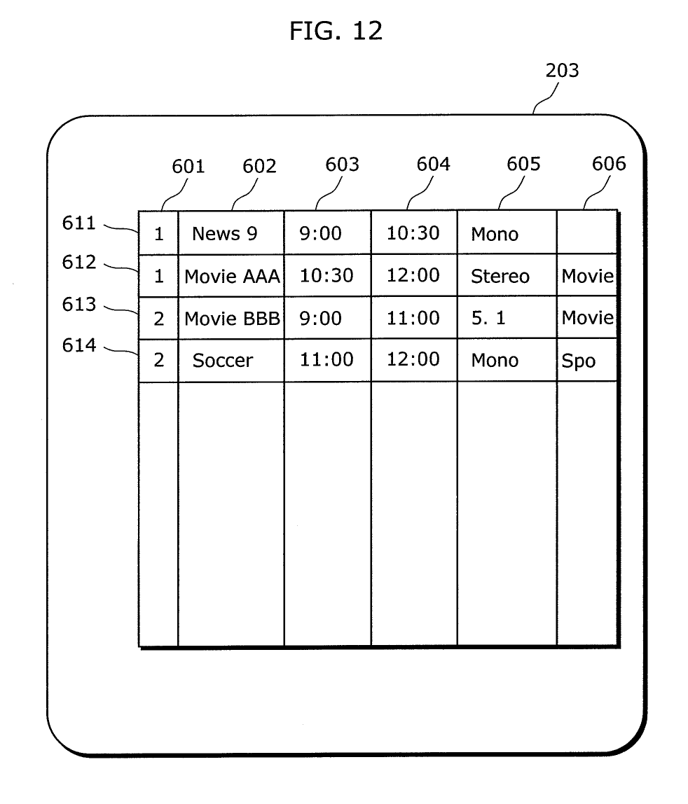

FIG. 12 shows an example of TV-program information stored in the second memory 203. The TV-program information is stored in tabular form. A column 601 describes the identifiers of channels. A column 602 describes TV-program names. A column 603 describes the broadcast start times of the TV-programs, and a column 604 describes the broadcast end times. A column 605 describes the sound type of the programs, and indicates mono sound, stereo sound, and 5.1 channel sound as “mono”, “stereo”, and “5.1”, respectively. A column 606 describes the type of the programs. A regular TV-program is described as an empty cell, a movie is described as “movie”, and a sports program is described as “spo”. Each of rows 611 to 614 describes information for one TV-program. In this example, one TV-program information is the set of the channel identifier, channel name, broadcast start time, broadcast end time, and TV-program sound type. For example, the row 611 describes a set which includes “1” as the channel identifier, “news 9” as the TV-program name, “9:00” as the broadcast start time, “10:30” as the broadcast end time, “mono” as the sound-type, and “regular” as the TV-program type.

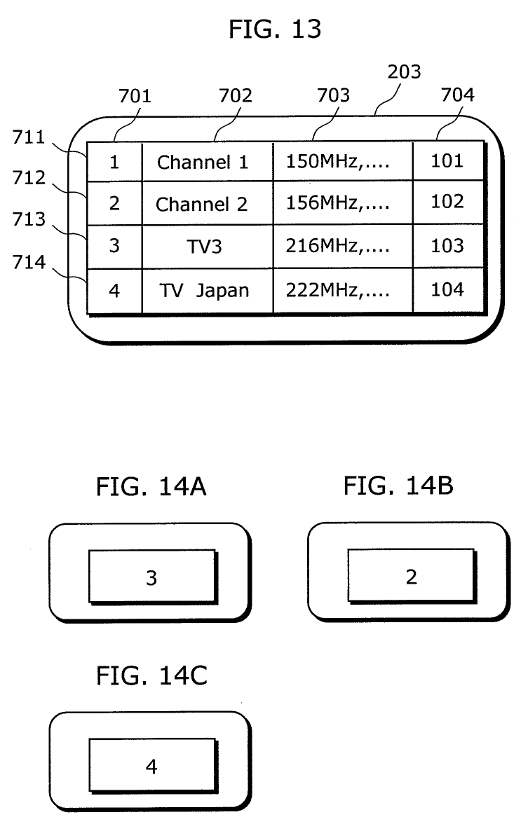

The reproduction unit 402b reproduces a channel using the received identifier of the channel. In other words, it reproduces the video and audio making up the channel. The relationship between channel identifiers and channels is pre-stored in the second memory 203 as channel information. FIG. 13 shows an example of the channel information stored in the second memory 203. The channel information is stored in tabular form. A column 701 describes the identifiers of channels. A column 702 describes channel names. A column 703 describes tuning information. Here, the tuning information are values to be provided to the receiving unit 204, such as frequency, transmission rate, and coding ratio. A column 704 describes program numbers. Program numbers are numbers used to identify PMTs defined by the MPEG2 standard. A description about PMT is given later. Each of rows 711 to 714 indicates a set of the identifier, channel name, and tuning information of each channel. The row 711 describes a set that includes “1” as an identifier, “Channel 1” as a channel name, a frequency of “150 MHz” as tuning information, and “101” as a program number. The reproduction unit 402b passes the identifier of the received channel directly to the service manager 404 in order to reproduce the channel.

Moreover, when the user presses down the up-cursor 301 and the down-cursor 302 on the front panel 300 while the reproduction is taking place, the reproduction unit 402b receives a notification about such pressing from the input unit 201 through the CPU 212, and changes the channel being reproduced accordingly. When the up-cursor 301 is pressed down, a channel having the next lower channel identifier to that of the currently-reproduced channel is reproduced, and when the down-cursor 302 is pressed down, a channel having the next higher channel identifier to that of the currently-reproduced channel is reproduced. First, the reproduction unit 402b stores, in the second memory 203, the identifier of the channel that is currently reproduced. FIG. 14A, FIG. 14B and FIG. 14C show example identifiers of channels stored in the second memory 203. FIG. 14A shows that an identifier “3” is stored, and by referring to FIG. 13, it is shown that a channel having the channel name “TV 3” is currently being reproduced. When the user presses down the up-cursor 301 in a state illustrated in FIG. 14A, the reproduction unit 402b refers to the channel information shown in FIG. 13, and passes the identifier “2” of a channel with the channel name of “Channel 2” to the service manager 404 in order to switch reproduction to the channel with the channel name of “Channel 2” which is the channel having an identifier that is one value lower than that of the channel currently being reproduced. At the same time, the reproduction unit 402b rewrites the identifier stored in the second memory 203 to the channel identifier “2”. FIG. 14B shows the state in which the channel identifier has been rewritten. Furthermore, when the user presses down the down-cursor 302 in a state illustrated in FIG. 14A, the reproduction unit 402b refers to the channel information shown in FIG. 13, and passes the identifier “4” of a channel having the channel name of “TV Japan” to the service manager 404 in order to switch reproduction to the channel having the channel name of “TV Japan” which is the channel having an identifier which is one value higher than that of channel currently being reproduced. At the same time, the reproduction unit 402b rewrites the identifier stored in the second memory 203 to the channel identifier “4”. FIG. 14C shows the state in which the channel identifier has been rewritten. The channel identifier is saved, even when power to the content information outputting apparatus 101 is cut-off, since it is stored in the second memory 203.

In addition, upon being activated when power to the content information outputting apparatus 101 is turned on, the reproduction unit 402b reads the channel identifier stored in the second memory 203. Then, the reproduction unit 402b passes such channel identifier to the service manager. With this, when power is turned on, the content information outputting apparatus 101 is able to start the reproduction of the last channel that was being reproduced at the time of its previous operation.

The Java VM 403 is a Java virtual machine that sequentially analyzes and executes programs written in the Java™ language. Programs written in the Java language are compiled into intermediate codes known as a byte code which are not dependent on hardware. A Java virtual machine is an interpreter that executes such byte code. Some Java virtual machines pass the byte code to the CPU 212 after translating the byte code into an execution format which can be interpreted by the CPU 212, and executes it. The Java VM 403 is activated, with a Java program to be executed being specified by the kernel 401a. In the present embodiment, the kernel 401a specifies the service manager 404 as the Java program to be executed. Details of the Java language are described in many publications such as “Java Language Specification (ISBN 0-201-63451-1)”. Here, such details are omitted. Furthermore, the detailed operation of the Java VM itself is described in many publications such as “Java Virtual Machine Specification (ISBN 0-201-63451-X)”. Here, such details are omitted.

The service manager 404, which is a Java program written in the Java language, is sequentially executed by the Java VM 403. It is possible for the service manager 404 to call or be called by another subprogram not written in the Java language, through the Java Native Interface (JNI). The JNI is also described in many publications such as in the book “Java Native Interface” and so on. Here, such details are omitted.

First the process in the case of receiving a digital broadcast, and reproducing the received multimedia data shall be described.

The service manager 404 accepts the identifier of a channel from the reproduction unit 402b, through the JNI.

The service manager 404 first passes the identifier of the channel to the Tuner 405c in the library 405, and requests for tuning. The Tuner 405c refers to the channel information stored in the second memory 203, and obtains the tuning information. Now, when the service manager 404 passes the identifier “2” of the channel to the Tuner 405c, the Tuner 405c refers to the column 712 shown in FIG. 13, and obtains the corresponding tuning information “156 MHz”. The Tuner 405c passes the tuning information to the receiving unit 204 through tuner 401b1 of the library 401b of the OS 401. The receiving unit 204 performs demodulation on the signal transmitted from the broadcast station, based on the provided tuning information, and passes the result to the demultiplex unit 205.

The service manager 404 requests the CA 405d inside the Java library 405 to perform descrambling. The CA 405d provides the descrambler 206 with information required for descrambling, through the condition-release 401b2 of the library 401b in the OS 401. On the basis of such provided information, the descrambler 206 descrambles the signal provided by the receiving unit 204, and passes the result to the TS decoder 207.

The service manager 404 provides the identifier of the channel to a JMF 405a inside the Java library 405, and requests for the reproduction of the video and audio.

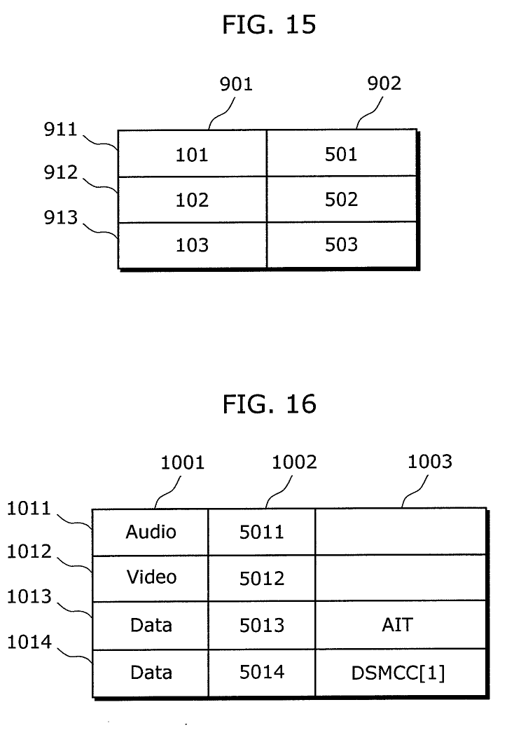

First, the JMF 405a obtains, from a PAT and a PMT, packet IDs used to specify the video and audio to be reproduced. PAT and PMT are tables stipulated by the MPEG2 standard that show the TV-program line-up included in an MPEG2 transport stream. PAT and PMT are embedded in the payloads in packets included in an MPEG2 transport stream, and sent together with audio and video. Refer to the Specification for details. Here, only the outline shall be described. PAT, which is an abbreviation of Program Association Table, is stored and sent in packets with the packet ID “0”. In order to obtain the PAT, the JMF 405a specifies, to the demultiplex unit 205, the packet ID “0”, through the library 401b of the OS 401. The demultiplex unit 205 performs filtering based on the packet ID “0” and, by passing the result to the CPU 212, the JMF 405a collects the PAT packets. FIG. 15 is a chart which schematically shows an example of information of the collected PAT. A column 901 describes program numbers. A column 902 describes packet IDs. The packet IDs shown in the column 902 are used to obtain the PMT. Each of rows 911 to 913 is a pair of the program number of a channel and a corresponding packet ID. Here, three channels are defined. The row 911 defines a pair of the program number “101” and the packet ID “501”. Now, when the channel identifier provided to the JMF 405a is “2”, the JMF 405a refers to the column 912 in FIG. 15, so as to obtain the corresponding program number “102”, and then refers to the column 912 in the PAT shown in FIG. 15, so as to obtain the packet ID “502” corresponding to the program number “102”. PMT, which is an abbreviation of Program Map Table, is stored and sent in packets of the packet ID stipulated in the PAT. In order to obtain the PMT, the JMF 405a specifies, to the demultiplex unit 205, the packet ID, through the library 401b of the OS 401. Here, it is assumed that the packet ID specified is “502”. The demultiplex unit 205 performs filtering based on the packet ID “502” and, by passing the result to the CPU 212, the JMF 405a collects the PMT packets. FIG. 16 is a chart which schematically shows an example of information of the collected PMT. A column 1001 describes stream types. A column 1002 describes packet IDs. Information specified in the respective stream types is stored and sent in the payloads of packets with the packet IDs specified in the column 1002. A column 1003 describes supplementary information. Each of columns 1011 to 1014 is a pair of a packet ID and the type of information being transmitted, which is known as an elementary stream. The column 1011, which is a pair of the stream type “audio” and the packet ID “5011”, indicates that audio data is stored in the payload of the packet with the packet ID “5011”. The JMF 405a obtains, from the PMT, the packet IDs of the video and audio to be reproduced. Referring to FIG. 16, the JMF 405a obtains the audio packet ID “5011” from the row 1011, and the video packet ID “5012” from the row 1012.

Next, the JMF 405a passes the obtained audio packet ID and video packet ID to the AV reproduction 401b3 of the library 401b of the OS 401. Upon receiving this, the AV reproduction 401b3 provides the received audio packet ID and video packet ID to the TS decoder 207. The TS decoder 207 performs filtering based on such provided packet IDs. Here, the packet with the packet ID “5011” is passed to the audio output unit 209, and the packet with the packet ID “5012” is passed to the video output unit 208. The audio output unit 209 converts (for example, digital-analog conversion) the provided packet, as necessary, and outputs this. The video output unit 208 converts (for example, digital-analog conversion) the provided packet, as necessary, and outputs this.

Finally, the service manager 404 provides the channel identifier to an AM 405b inside the Java library 405, and requests for data broadcast reproduction. Here, data broadcast reproduction refers to extracting a Java program included in the MPEG2 transport stream, and having it executed by the Java VM 403. As a method of inserting a Java program into an MPEG2 transport stream, a method referred to as DSMCC, which is described in the MPEG Standard ISO/IEC 13818-6, is being used. Here, detailed description of DSMCC shall be omitted. The DSMCC format defines a method of encoding, in packets within an MPEG2 transport stream, a file system made up of directories and files used by a computer. Furthermore, information about the Java program to be executed is embedded and sent in packets in the MPEG2 transport stream in a format referred to as AIT. AIT is an abbreviation of Application Information Table defined in the 10th chapter of the DVB-MHP Standard (formally as, ETS TS 101 812 DVB-MHP Specification V1.0.2).

First, in order to obtain the AIT, the AM 405b obtains the PAT and PMT as in the case of the JMF 405a, so as to obtain the packet ID of the packet that stores the AIT. Now, when “2” is the identifier of the provided channel and the PAT shown in FIG. 15 and the PMT shown in FIG. 16 are being transmitted, the AM 405b obtains the PMT shown in FIG. 16 according to the same procedure followed by the JMF 405a. The AM 405b extracts, from the PMT, the packet ID of the elementary stream having a stream type of “Data” and which has “AIT” as supplementary information. Referring to FIG. 16, the elementary stream in the row 1013 corresponds to such description, and therefore the AM 405b obtains the packet ID “5013”.

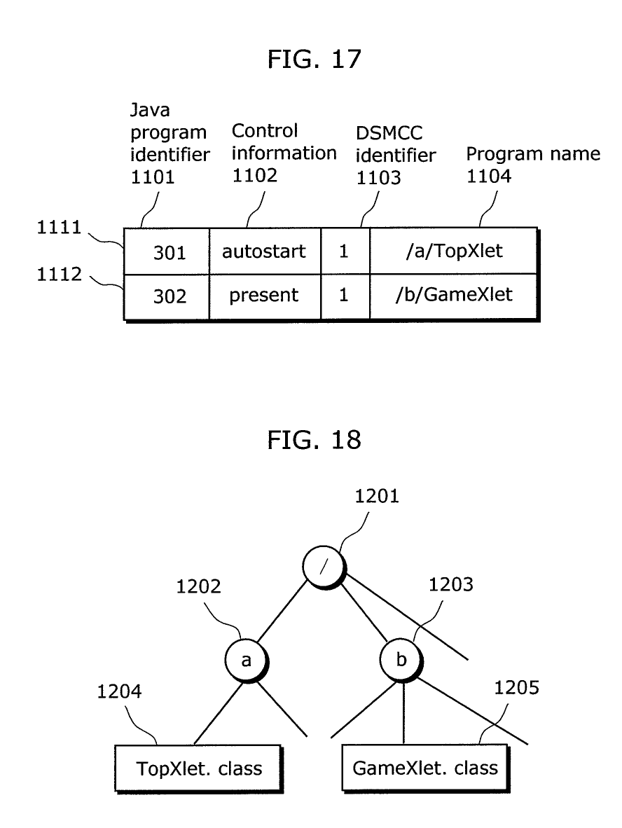

The AM 405b provides the packet ID of the AIT to the demultiplex unit 205, through the library 401b of the OS 401. The demultiplex unit 205 performs filtering based on such provided packet ID, and passes the result to the CPU 212. As a result, the AM 405b can collect the packets of AIT. FIG. 17 is a chart which schematically shows an example of information of the collected AIT. A column 1101 describes the identifiers of Java programs. A column 1102 describes control information of the Java programs. The control information includes “autostart”, “present”, and “kill”. “autostart” means that the content information outputting apparatus 101 automatically executes the program immediately. “present” means that the program is not executed automatically. “kill” means that the program is to be terminated. A column 1103 describes DSMCC identifiers for extracting packet IDs including a Java program in the DSMCC format. A column 1104 describes program names of the Java programs. Each of rows 1111 and 1112 is a set of information about a Java program. The Java program defined in the row 1111 is a set of an identifier “301”, control information “autostart”, a DSMCC identifier “1”, and a program name “a/TopXlet”. The Java program defined in the row 1112 is a set of an identifier “302”, control information “present”, a DSMCC identifier “1”, and a program name “b/GameXlet”. Here, the two Java programs have the same DSMCC identifier which indicates that two Java programs are included within a single file system encoded in the DSMCC format. Here, only four items of information are stipulated for the respective Java programs, but more items of information are specified in actuality. Refer to the DVB-MHP standard for details.

The AM 405b finds the “autostart” Java program from within the AIT, and extracts the corresponding DSMCC identifier and Java program name. Referring to FIG. 17, the AM 405b extracts the Java program in the row 1111, and obtains the DSMCC identifier “1” and the Java program name “a/TopXlet”.

Next, using the DSMCC identifier obtained from the AIT, the AM 405b obtains, from the PMT, the packet ID of packets that store Java programs in the DSMCC format. More specifically, the AM 405b obtains, from within the PMT, the packet ID of the elementary stream whose stream type is “Data” and having a matching DSMCC identifier in the supplementary information.

Now, assuming that such DSMCC identifier is “1” and the PMT is that shown in FIG. 16, the elementary stream in the row 1014 matches, and the packet ID “5014” is to be extracted.

The AM 405b specifies the packet ID of the packet in which data is embedded in the DSMC format, to the demultiplex unit 205, through the library 401b of the OS 401. Here, the packet ID “5014” is provided. The demultiplex unit 205 performs filtering based on such provided packet ID, and passes the result to the CPU 212. As a result, the AM 405b can collect the required packets. The AM 405b reconstructs the file system from the collected packets, according to the DSMCC format, and stores this in the first memory 202 or the second memory 203. Extracting the data of a file system, and the like, and storing this in the first memory 202 or the second memory 203 shall hereafter be referred to as download.

FIG. 18 shows an example of a downloaded file system. In the figure, a circle denotes a directory and a square denotes a file. 1201 denotes a root directory, 1202 denotes a directory “a”, 1203 denotes a directory “b”, 1204 denotes a file “TopXlet.class”, and 1205 denotes a file “GameXlet.class.

Here, although an example of downloading a file system from an MPEG2 transport stream is described, the OCAP specification also stipulates downloading using an IP network, and so on. Furthermore, a method for identifying the location of a file system using information referred to as XAIT, instead of AIT, and downloading the file system is also stipulated.

Next, the AM 405 passes, to the Java VM 403, the Java program to be executed from within the file system downloaded into the first memory 202 or the second memory 203. Here, when the name of the Java program to be executed is “a/TopXlet”, the file “a/TopXlet.class”, having “.class” added to the end of the Java program name, is the file to be executed. “/” is a division of a directory and file name and, by referring to FIG. 18, the file 1204 is the Java program to be executed. Next, the AM 405b passes the file 1204 to the Java VM 403.

The Java VM 403 executes the Java program passed to it.

Upon receiving an identifier of an other channel, the service manager 404 stops the execution, though the respective libraries included in the Java library 405, of the video/audio and Java program currently being reproduced likewise through the respective libraries included in the Java library 405, and performs the reproduction of video/audio and execution of a Java program based on the newly received channel identifier.

Furthermore, the service manager 404 also includes a function for receiving the identifier of a channel from a Java program executed on the Java VM 403, aside from the reproduction unit 402b. Specifically, a Java language class for obtaining the identifier of the channel, and the method thereof, are provided. Upon receiving an identifier of a channel, the service manager 404 stops the execution, though the respective libraries included in the Java library 405, of the video/audio and Java program currently being reproduced likewise through the respective libraries included in the Java library 405, and subsequently performs the reproduction of new video/audio and the execution of a lava program based on the newly received channel identifier.

Next, the operation of receiving a digital broadcast and storing the multimedia data thereof, in the content information outputting device 101 shall be described.

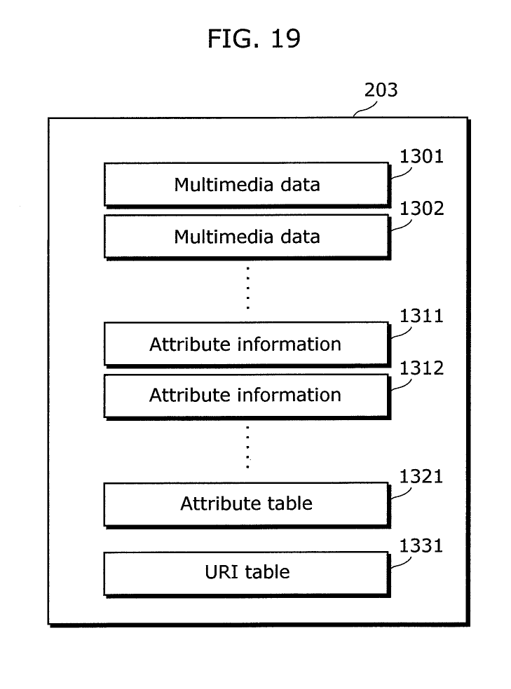

FIG. 19 is an example of the form of the storing of multimedia data into the second memory 203 by the content information outputting apparatus 101. The content information outputting apparatus 101 stores, in the second memory 203, multimedia data and its attribute information, an attribute information table, and a URI table. In FIG. 19, 1301, 1302, . . . denote multimedia data, 1311, 1312, . . . denote attribute information of the multimedia data, 1321 denotes an attribute information table, and 1331 denotes a URI table. The multimedia data 1301, 1302, . . . are multimedia data encoded in the MPEG2 TS format. The attribute information 1311, 1312, . . . are additional information such as the title of each multimedia data. Here, the attribute information 1311 describes attribute information of the multimedia data 1301, the attribute information 1312 describes attribute information of the multimedia data 1302.

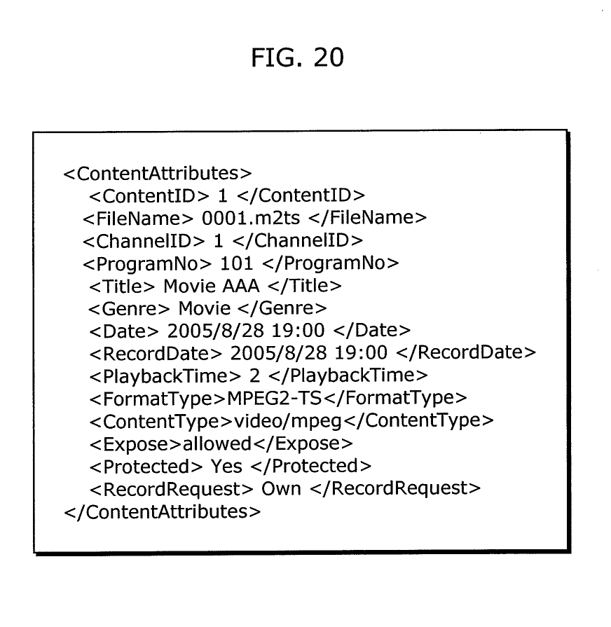

FIG. 20 shows an example of attribute information in the present embodiment. In the present embodiment, attribute information is text defined in the Extensible Markup Language (XML). In FIG. 20, a ContentID element describes the identifier of a content; a FileName element describes the filename of the multimedia data; a ChannelID element describes an identifier of a channel on which the TV-program was broadcast, as in column 601 in FIG. 12; a ProgramNo element describes a program number for searching the PMT, as in column 704 in FIG. 13; a Title element describes the TV-program name as in column 602 in FIG. 12; a Genre element describes the type of the program, as in column 606 in FIG. 12; a Date element describes the date and time the TV-program was broadcast; a RecordDate element describes the date and time the TV-program was recorded; a PlaybackTime element describes the number of times the multimedia data has been reproduced or outputted to the network 104; a FormatType element describes the type of the media format of the content; a ContentType element describes the Content-Type assigned to the media format of the content from the Internet Assigned Numbers Authority (IANA); an Expose element describes whether or not outputting of the content to the network is permitted; a Protected element describes whether or not the content is a protected video content; and a RecordRequest element describes the apparatus requesting the recording or scheduled recording of the content. Here, in the present embodiment, it is assumed that when the Expose element shows a value of “allowed” or there is no Expose element, outputting to the network is permitted. When there is an Expose element and the value is not “allowed”, outputting to the network is not permitted. Furthermore, the Protected element indicates a protected video content, and indicates a general video content when its value is “Yes”, and when there is no Protected element or its value is something other than “Yes”. The value of the RecordRequest element is set with a value that is unique for each device, such as the content information outputting apparatus 101, the content information receiving apparatus 102, and the terminal 103. For example, the nickname, serial number, device ID, IP address, or MAC address of the device can be an example thereof. However, it is assumed that when the value shows “Own”, this indicates that the recording was requested by the content information outputting apparatus 101 itself. Furthermore, the content identifier indicated by the Content ID element is an identifier assigned by the broadcast operator or the rights holder for the content, which uniquely identifies the content and which can be obtained from information not shown within the EPG data. Universally Unique Identifier (UUID), and the like, is used for the format for this identifier. In the present embodiment, the integer-type is used for the sake of simplicity. Furthermore, the attribute information is not limited to the XML configuration, and recording in other formats such as binary data is also possible.

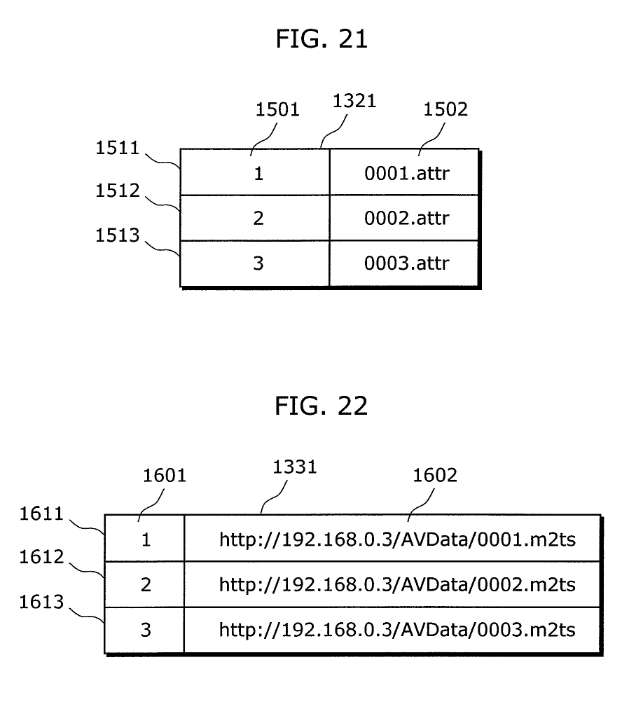

The attribute information table is a correspondence chart for the identifier of the content, the file on which the multimedia data of the content indicated by the identifier is recorded, and the file on which the attribute information is recorded. FIG. 21 shows an example thereof. In FIG. 21, a column 1501 describes the content identifiers, and a column 1502 describes file names of the attribute information. Rows 1511 to 1513 are pairs of the content identifier and the file name of the corresponding attribute information. From column 1511, it can be read that the attribute information of the content for identifier 1 is recorded in the file 0001.attr.

FIG. 22 shows an example of the structure of the URI table 1331. In FIG. 22, a column 1601 describes the identifiers of respective contents, and a column 1602 describes URIs for accessing the respective contents. Rows 1611 to 1613 show pairs of the identifier and URI of respective contents. For example, row 1611 indicates that the URI of the content for identifier 1 is http://192.168.0.3/AVData/0001.m2ts.

Hereinafter, the storing process shall be described. First, the operation up to descrambling is the same as in the case of the previously described reproduction. Next, the service manager 404 requests, the CA 405d, for the obtainment of protection necessary/unnecessary information concerning the multimedia data and, in the case where protection is necessary, information on the kind of protection. This information shall be called protection information. The CA 405d receives the protection information of the multimedia data from the descrambler 206, and passes this to the service manager 404. Next, the service manager 404 judges, from the protection information passed on to it, whether or not the multimedia data can be stored. Only in cases where storing is possible does the service manager 404 request the storing of the multimedia data, to the Rec 405j inside the Java library 405. The Rec 405j first obtains the PAT and PMT in the same manner as the JMF 405a and AM 405b, and obtains packet IDs for the video data, audio data, and respective section data relating to the TV-program to be stored. Now, when “2” is the identifier of the provided channel and the PAT shown in FIG. 15 and the PMT shown in FIG. 16 are being transmitted, the Rec 405j obtains the PMT shown in FIG. 16 according to the same procedure followed by the JMF 405a. The data to be stored are all the data described in the PMT in FIG. 16.

The Rec 405j provides these packet IDs to the decoder 207 through the library 401b of the OS 401 and causes these to be outputted to the TS multiplexer 210. The TS decoder 207 performs filtering based on such provided packet IDs, and passes the result to the TS multiplexer 210. Furthermore, with regard to the section data, it is possible that a version number is assigned to each section data, and that the TS decoder 207 outputs data of the same type only once for each version number, and filters the rest.

The Rec 405j provides, to the TS multiplexer 210 through the library 401b of the OS 401, the number of types of data to be transmitted, and causes the configuration of an MPEG2 transport stream from the data passed on from the TS decoder 207. The TS multiplexer 210 passes the configured MPEG transport stream to the CPU 212.

In addition, the Rec 405j writes, into the second memory, the MPEG transport stream received by the CPU 212 from the TS multiplexer, by requesting the IO 405g inside the Java library 405. In addition, the Rec 405j receives the channel identifier of the channel by requesting the service manager 404, and reads the TV-program information corresponding to the stored multimedia data from among the TV-program information stored in the second memory 203 shown in FIG. 12, by requesting the IO 405g. In addition, the Rec 405j obtains the protection information of the stored multimedia data, and the identifier of the stored multimedia data, by requesting the service manager 404. Furthermore, the Rec 405j creates attribute information from the obtained TV-program information, protection information of the multimedia data, and the file name under which the multimedia is stored, and writes the attribute information into the second memory 203 by requesting the IO 405g. In addition, the Rec 405j reads the attribute information table by requesting the IO 405g, updates the attribute information and, by requesting the IO 405g, updates the information table by writing into the second memory 203.

Note that although, in the present embodiment, the descrambler 206 obtains the protection information of the content and passes this to the CPU 212, it is also possible to have the demultiplex unit 205 or the TS decoder 207 obtain the protection information and pass this to the CPU 212. Alternatively, it is also possible to provide a unit which communicates with the broadcast station 106 and receive the protection information separately from the broadcast station 106. Alternatively, it is also possible to embed and broadcast the protection information in a PMT, and have the TS decoder 207 or the CPU 212 extract the protection information from the PMT.

Furthermore, the protection information of the attribute information file may be set and updated by a Java application after storing.

Next, the processing in the case of outputting the multimedia data of a received digital broadcast from the network unit 211.

First, the network library 405e located inside the Java library 405 receives a request from a terminal connected to the network 104, and provides the identifier of the channel being requested, to the service manager 404. The service manager 404 provides the received channel identifier to the Tuner 405c and requests tuning, then requests descrambling and the obtainment of the protection information to the CA 405d. Next, the service manager 404 passes the protection information to the network library 405e, and returns the process.

Next, when, based on the protection information, multimedia data can be outputted, the service manager 404 notifies the network library 405e that the outputting is possible, and returns the process. In the case where outputting is not possible, the service manager 404 requests the CA 405d to terminate the descrambling and, in addition, notifies the network library 405e that outputting is not possible, then returns the processing.

The network library 405e judges whether or not the multimedia data can be transmitted to the terminal, based on the received protection information and the attribute of the terminal making the request. When not transmittable, the network library 405e creates a message for notifying such fact, transmits the message to the terminal, and ends the process. Note that, in addition, the network library 405e may provide the channel identifier to the service manager 404, and request the Tuner 405c to cancel the tuning, and the CA 405d to cancel the descrambling.

When outputting is possible, the network library 405e controls the TS decoder 207 and the TS multiplexer 210 and creates an MPEG transport stream from the video data, audio data, and section data of the TV-program, in the same manner as the Rec 405j described above.

In addition, the network library 405e provides the address of the transmission destination to the NET 401b4 of the library 401b of the OS 401. Next, the network library 405e converts the MPEG2 transport stream received from the TS multiplexer 210 into a format that is in accordance with the protocol of the application level to be transmitted, and outputs this sequentially to the NET 401b4. An application level protocol refers to, for example, HTTP, RTP, and so on. With this, the NET 401b4 refers to the transmission destination address, and converts the data passed on to it into IP network packets and passes these to the network unit 211. The network unit 211 converts the data passed on to it into a signal that is in accordance with the physical media of the network connected to, and outputs this signal.

Next, the process in the case of reproducing multimedia data stored in the second memory 203 shall be described. Upon receiving the content identifier, the service manager 404 reads the attribute information table 1321 from the second memory 203 and searches for the file on which the attribute information of the contents for the identifier is recorded, by requesting the IO 405g inside the Java library 405. In the attribute information table in FIG. 21, when the content identifier is 1, the file is 0001.attr. Next, by requesting the IO 405g, the service manager 404 reads the file on which the attribute information is recorded, from the secondary memory 203. The service manager 404 obtains the file name on which the multimedia data of the content is recorded, from the read attribute information. In the case of the attribute information in FIG. 20, 0001.m2ts corresponds to the file name.

Next, by requesting the IO 405g, the service manager 404 reads the MPEG transport stream from the file of the multimedia data. The IO 405g reads the data through the library 401b of the OS 401, and passes the data to the CPU 212. The service manager 404 passes the read MPEG transport stream to the demultiplex unit 205, through the library 401b of the OS 401.

In addition, the service manager 404 requests the CA 405d inside the Java library to allow the data to pass through without being descrambled by the descrambler. The CA 405d provides the descrambler 206 with information, through the condition-release 401b2 of the library 401b in the OS 401. With this, the descrambler 206 passes the data passed on to it by the demultiplex unit 205, as-is, to the TS decoder 207.

In addition, the service manager 404 reads the channel identifier or program number from the read attribute information, provides this to the JMF 405a inside the lava library 405, and requests for reproduction. Hereafter, the reproduction of video data and audio data is performed according to the same process as in the previously described case of a content received from a broadcast.

Furthermore, the service manager 404 provides the channel identifier or the program number to the AM 405b inside the lava library, and requests for data broadcast reproduction. Hereafter, the data broadcast reproduction is performed according to the same process as in the previously described case of a content received from a broadcast.

Next, the process of transmitting a list of multimedia data that can be provided in response to a request from among the multimedia data stored in the second memory 203, according to the request from a terminal connected to the network 104 shall be described.

First, upon receiving a list transmission request from the terminal, the network library 405e reads the attribute information table 1321 stored in the second memory 203 by requesting the IO 405g. In addition, the network library 405e sequentially reads the attribute information files written in each row of the attribute information table 1321. In the example in FIG. 21, 0001.attr, 0002.attr, and 0003.attr are sequentially read. The network library 405e first checks the Expose element of the read attribute information file, and judges whether or not outputting through the network 104 is permitted. When not permitted, the network library 405e moves on to the reading of the next attribute information file. When permitted, the network library 405e next judges, based on the FormatType element, ContentType element, Title element, and so on, whether or not the multimedia data matches the property, such as the media format, title, and so on, requested by the terminal. When not matching, the network library 405e moves on to the reading of the next attribute information file. When matching, the network library 405e subsequently judges whether or not the multimedia data is a protected video content, by checking the Protected element. In the case of a protected video content, the network library 405e judges whether or not the request-source terminal has the right to use a protected video content. In the case where the request-source terminal has the use right, the multimedia data is included in the list as a usable content. Furthermore, in the case where the request-source terminal does not have the use right, the multimedia data is not included in the list, as it is an unusable content, and the network library 405e moves on to the reading of the next attribute information file. Furthermore, in the case where the multimedia data is a general video content, the network library 405e judges that the multimedia data is a usable content, and includes this in the list. The process for inclusion into the list is as follows. By requesting the IO 405g, the network library 405e reads the URI table 1331 and obtains a URI for accessing the multimedia data. This URI and the attribute information file of the multimedia are included, together as one item, in a reply message to the Search request, defined by the DLNA, UPnP AV, and so on.

The network library 405e performs the aforementioned process on all contents stored in the second memory 203, and transmits the generated message to the request-source terminal.

Next, the process of transmitting, from among the multimedia data stored in the second memory 203, multimedia data requested by a terminal connected to the network 104 to the request-source terminal shall be described.

First, the network library 405e analyzes the request message transmitted from the request-source terminal, and obtains the URI of the requested content. This is carried out through the network library 405e analyzing the activated server module, the port number of the server to which the terminal has connected with, and the request message. Next, the network library reads the URI table 1331 by requesting the IO 405g. The identifier of the requested content is obtained from the read URI table 1331 and the URI obtained from the request message. For example, in the URI table shown in FIG. 22, when the requested URI is http://192.168.0.3/AVData/0001.m2ts, a content identifier 1 is obtained from the details in row 1611.

Next, the network library 405e reads the attribute information table 1321 by requesting the IO 405g. Subsequently, the file name of the attribute information file of the content is obtained based on the identifier of the requested content. For example, in the attribute information table 1321 shown in FIG. 21, it can be seen that the attribute information file of the content of identifier 1 is 0001.attr.

Next, the network library 405e reads the attribute information of the obtained file name by requesting the IO 405g. The network library 405e obtains, from the FileName element among the read attribute information, the file name on which the multimedia data of the content is recorded. For example, in the case of the attribute information file shown in FIG. 20, it can be seen that the file name of the multimedia data is 0001.m2ts.

Next, the network library 405e verifies the presence of the multimedia data of the obtained file name by requesting the IO 405g. When not present, the network library 405e generates an error message, transmits this to the request-source terminal, and ends the process. When present, the network library 405e collects information, such as information on the attribute information file and the file size, which are obtainable by requesting the IO 405g, generates the header of a reply message, and transmits the header to the request-source terminal. Next, by requesting the IO 405g, the network library 405e sequentially reads the multimedia data and transmits the read data to the request-source terminal.

Note that, before transmitting the multimedia data, it is possible to perform judgment as to whether or not the content can be transmitted, as performed during the above-described list transmission request processing. With this, there is an effect of enabling more accurate prevention of unauthorized use.

The Java library 405 is a collection of plural Java libraries stored in the second memory 203. In the present embodiment, the Java library 405 includes the JMF 405a, the AM 405b, the Tuner 405c, the CA 405d, the network library 405e, a reproduction Lib 405f, the IO 405g, an AWT 405h, an SI 405i, and the Rec 405j, and so on.

Since the functions of the JMF 405a, the AMF 405b, the Tuner 405c, the CA 405d, the Rec 405j have already been described, further description shall be omitted.

The reproduction Lib 405f provides the class and method of the Java language (hereafter called Java API) for passing, to the Java program, the identifier of the channel currently being reproduced, which is stored in the second memory 203. By using this Java API, the Java program is able to recognize the channel that is currently being reproduced.

The IO 405g provides, to the Java program, a Java API for the writing of data to the second memory 203 by the Java program, or a Java API for the reading of such data which has been written into the second memory 203. By using this API, the Java program is able to store arbitrary data in the secondary memory 203. Since such stored data is not erased even when power to the content information outputting apparatus 101 is turned off, the data can be read again after power to the content information outputting apparatus 101 is turned on.

The AWT 405h provides a Java API for drawing or for the reception of a key input notification from the input unit 201 by the Java program. To be more specific, these correspond to the java.awt package, java.awt.event package, and other java.awt subpackages described in “The Java class Libraries Second Edition, Volume 2” (ISBN0-201-31003-1). Here, detailed description shall be omitted.

The SI 405i provides a Java API for the obtaining of channel information and electric program information by the Java program. To be more specific, there are the Java TV Specification and the like. Furthermore, the MPEG section filter API for obtaining raw binary data from an MPEG2 transport stream currently being broadcast is defined in the OCAP Specification, and the Java application can understand and handle unique electric program data that has been transmitted.

The network library 405e, connected to the network 104, communicates with the content information receiving apparatus 102 and the terminal 103 through the NET 401b4 of the library 401b of the OS 401. Communication refers to the transmission of a content list and content data provided by the content information outputting apparatus 101, and the transmission of requests for recording, scheduled recording, and so on, from the content information receiving apparatus 102 and the terminal 103. Note that EPG data may be included in the content list transmitted by the content information outputting apparatus 101.

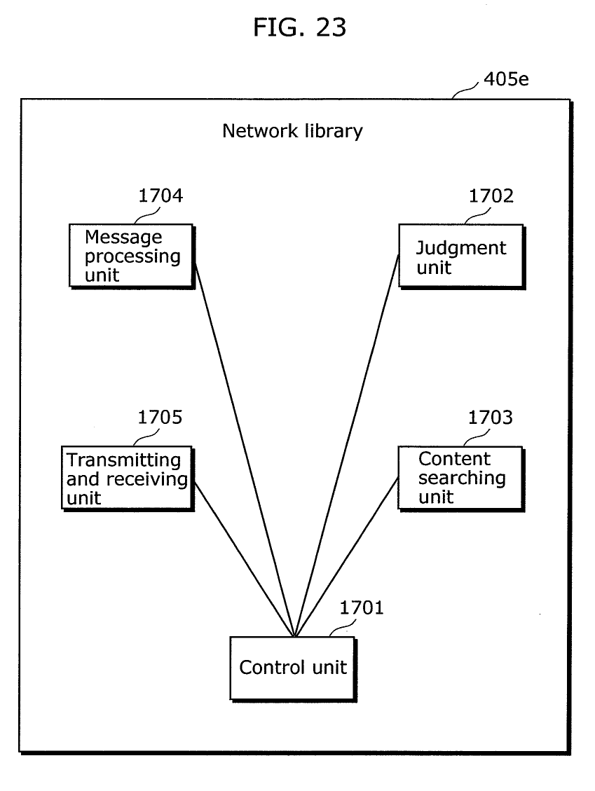

FIG. 23 is a block diagram showing an example of the internal configuration of the network library 405e. The network library 405e includes a control unit 1701, a determination unit 1702, a content searching unit 1703, a message processing unit 1704, and a transmitting and receiving unit 1705. Note that the network library 405e may include other functions relating to the IP network.

The control unit 1701 provides, to a downloaded Java application, the function for implementing the network library 405e. In other words, the control unit 1701 can execute a network-using function by providing a Java API to the Java application, and by the Java application calling such API. When the Java API is called, the control unit 1701 performs processes using the determination unit 1702, the content searching unit 1703, the message processing unit 1704, the transmitting and receiving unit 1705, and the rest of the Java library 405 and the library 401b of the OS 401, as necessary. Furthermore, the control unit 1701 carries out notifications to the Java application using a callback function of the Java application, as necessary.

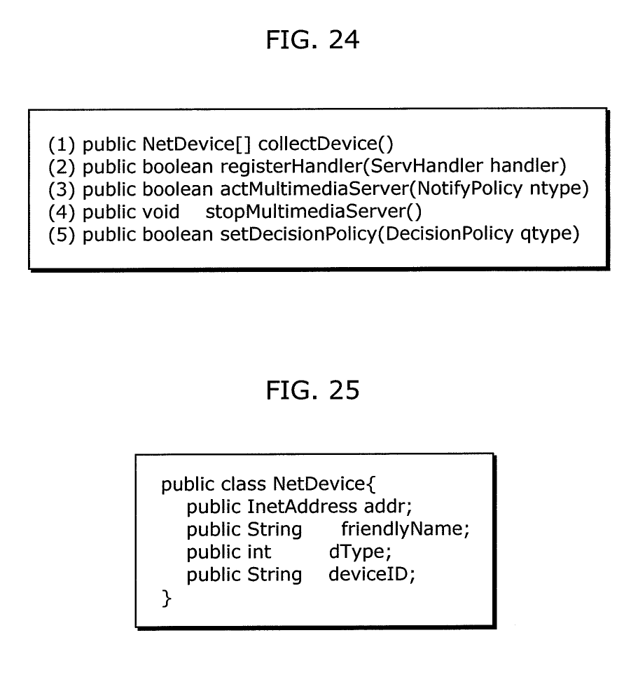

FIG. 24 is an example of the Java API provided by the control unit 1701. The method collectDevice( ) in FIG. 24(1) collects information on an external device connected to the network 104, and returns, as information thereon, the arrangement of NetDevice object. In the case of failure, null is returned. With this method, it is possible to obtain information on the device connected to the network 104. FIG. 25 shows an example of the structure of a NetDevice class. In FIG. 25, addr represents the network address of the device, friendlyName represents the nickname given to the device, dType represents the type of the device, 0 represents the content information outputting apparatus in the present invention, 1 represents the content information receiving apparatus in the present invention, 2 represents a general multimedia server which is a Digital Media Server (DMS) defined in DLNA and so on, and 3 represents a general Digital Media Player (DMP) such as the terminal 103. Furthermore, deviceID represents the identifier of the device. As an identifier, it is possible to use a MAC address, the serial number set by the manufacturer, an identifier set by the content rights holder or broadcast operator, and so on. Note that in the case where an identifier set by the content rights holder or broadcast operator is used, a value of null is assumed for a device that is not set with such an identifier. Such information obtainment can be carried out through a method defined in UPnP DA and minor extensions thereof, and thus detailed description of the process shall be omitted.

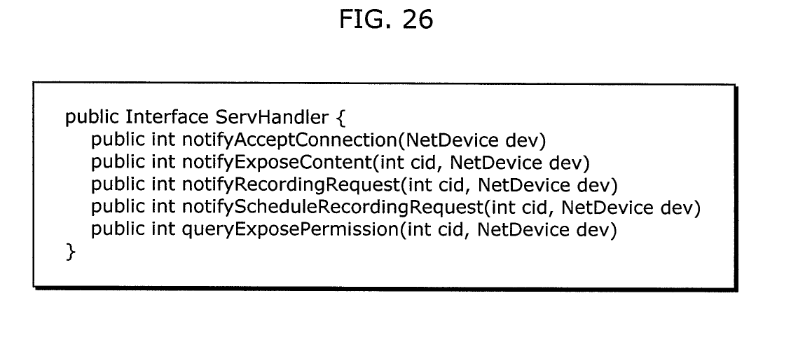

The method registerHandler( ) in FIG. 24(2) registers, into the system, a ServHandler interface-equipped handler which is provided through an argument handler, and returns true when successful and false in the case of a failure. By registering the handler, the lava application can receive a callback from the network library 405e. FIG. 26 shows an example of the structure of the ServHandler interface. In FIG. 26, the method notifyAcceptConnection( ) of the Serverhandler interface notifies, from the network library 405e to the lava application, the fact that the network connection from the device indicated by the argument dev has been accepted. It returns 0 in the case of normal ending, and returns an error code when any trouble occurs. Furthermore, the method notifyExposeContent( ) notifies, from the network library 405e to the Java application, the fact that the content of the identifier indicated by the argument cid has been outputted to the device indicated by the argument dev via the network 104. It returns 0 in the case of normal ending, and returns an error code when any trouble occurs. Furthermore, the method notifyRecordingRequest( ) notifies, from the network library 405e to the Java application, the fact that a recording request for the content indicated by the argument cid has been received from the device indicated by the argument dev. It returns 0 in the case of normal ending, and returns an error code when any trouble occurs. Furthermore, the method notifyScheduleRecordingRequest( ) notifies, from the network library 405e to the Java application, the fact that a scheduled recording request for the content indicated by the argument cid has been received from the device indicated by the argument dev. It returns 0 in the case of normal ending, and returns an error code when any trouble occurs. Note that since the recording request and the scheduled recording request via the network 104 can be carried out using UPnP Schedule Recording Service) SRS, detailed description shall be omitted. Furthermore, the method queryExposePermission( ) inquires, from the network library 405e to the Java application, about the judgment on whether or not the content indicated by the argument cid can be outputted to the device indicated by the argument dev. It returns a non-permission reason code, which is a positive integer value, when outputting is not permitted, and returns an error code, which is a negative value, when any trouble occurs. The argument dev of the method queryExposePermission( ) may also be null. In the case where the argument dev is not null, the method queryExposePermission( ) inquires about the outputting permission for a specific device, and inquires about the outputting permission for a general client device such as a DMP of the DLNA. Whether or not these callbacks to the Java application are to be carried out is set in the network library 405e from the Java application according to a QueryPolicy and NotifyPolicy described later.

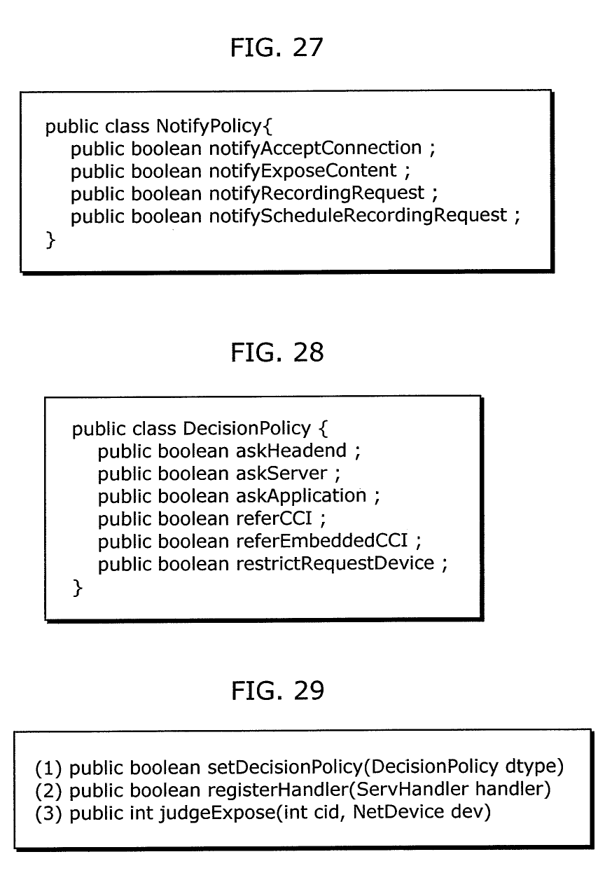

The method actMultimediaServer( ) in FIG. 24(3) requests, from the Java application to the network library 405e, the activation and operation of a multimedia server function. It returns true when the process ends normally, and returns false when an error occurs. When this method is called, the control unit 1701 of the network library 405e, as necessary, performs processing as a multimedia server providing multimedia data, by using the determination unit 1702, the content searching unit 1703, the message processing unit 1704, the transmitting and receiving unit 1705, and the rest of the Java library 405 and the library 401b of the OS 401, and in addition, by carrying out notification to the Java application and the service manager 404. The argument ntype sets whether or not there is a need for a callback from the network library 405e, and specifies this through the instance of the NotifyPolicy class. FIG. 27 shows an example of the NotifyPolicy class. In FIG. 27, a member variable notifyAcceptConnection of the NotifyPolicy class is a boolean variable. It sets the performance of a callback according to the method notifyAcceptConnection( ) of the handler equipped with the ServHandler interface set in the network library 405e in the case of true, and sets the non-performance of the callback in the case of false. Furthermore, a member variable notifyExposeContent is a boolean variable which sets the performance of a callback according to the method notifyExposeContent( ) in the case of true, and sets the non-performance of the callback in the case of false. Furthermore, a member variable notifyRecordingRequest is a boolean variable which sets the performance of a callback according to the method notifyRecordingRequest( ) in the case of true, and sets the non-performance of the callback in the case of false. Furthermore, a member variable notifyScheduleRecordingRequest is a boolean variable which sets the performance of a callback according to the method notifyScheduleRecordingRequest( ) in the case of true, and sets the non-performance of the callback in the case of false. Details of the operation of the method actMultimediaServer( ) shall be described later.

The method stopMultimediaServer( ) in FIG. 24(4) requests, from the lava application to the network library 405e, the termination of the multimedia server activated according to the method actMultimediaServer. When this method is called, the network library 405e terminates the operation of the currently activated multimedia server.

The method setDecisionPolicy( ) in FIG. 24(5) specifies, to the network library 405e, the method for performing the judgment for whether or not a content can be outputted. This is set with the value forwarded according to the argument dtype which is an instance of the DecisionPolicy class. The judgment is performed by the judgment unit 1702 to be described later. FIG. 28 shows an example of the DecisionPolicy class. Here, in FIG. 28, a member variable askHeadend of the DecisionPolicy class is a boolean variable and, when true, the network library 405e makes an outputting possible/not possible inquiry to the broadcast station 106; and when false, the inquiry is not made. Further, a member variable askServer is a boolean variable and, when true, the network library 405e makes an outputting possible/not possible inquiry to an external server; and when false, the inquiry is not made The external server is specified by the content rights holder and is obtained by the network library 405e through methods such as obtainment from an EPG via the service manager 404, obtainment through an inquiry to the broadcast station 106, or by being set, by the Java application, in an interface such as, for example, setJudgeServer( ). Furthermore, a member variable askApplication is a boolean variable and, when true, the network library 405e makes an outputting possible/not possible inquiry to the Java application; and when false, the inquiry is not made. Further, a member variable referCCI is a boolean variable and, when true, the network library 405e judges by referring to a CCI which is content copy information obtained from CableCARD, for example. When false, the CCI is not referred to. Further, a member variable referEmbeddedCCI is a boolean variable and, when true, the network library 405e judges by referring to a CCI embedded in the multimedia data of the content. When false, the CCI is not referred to. For example, in the case of an MPEG transport stream, the CCI of the content can be embedded into the PMT using a descriptor. Further, a member variable restrictRequestDevice is a boolean variable and, when true, the network library 405e judges that outputting is possible only for the device which requested the recording or scheduled recording of the content. When false, the device which requested the recording or scheduled recording is not taken into consideration. Note that in the case all these member variables are set as false, the network library 405e judges that all outputting of protected video content is not possible.

The judgment unit 1702 judges whether or not a content stored in the second memory 203 can be transmitted to a terminal.

The judgment unit 1702 provides a Java API to the other constituent elements of the network library 405e and the downloaded Java application. FIG. 29 is an example of the Java API provided by the judgment unit 1702. The method setDecisionPolicy( ) and method registerHandler( ) in FIG. 29(1) and (2), respectively, are the same as the method setDecisionPolicy( ) and the method registerHandler( ) of the control unit 1701, respectively.

Furthermore, the method judgeExpose( ) in FIG. 29(3) judges whether or not the content provided by the argument cid can be outputted to the device provided by the argument dev, according to a policy set in the setDecisionPolicy( ). It returns 0 in the case where it is judged that outputting is possible. In the case where outputting is not possible, it returns a positive integer value representing the reason therefor, and returns a negative integer value which is an error code in the case where any trouble occurs. The process for this method shall be described. When this method is called, the network library 405e first verifies whether or not a judgment policy has been set. In the case where a policy is not set, it returns a return value of a positive integer representing such fact. In the case where a policy is set, the network library 405e checks each member variable of the DecisionPolicy shown in FIG. 28 and verifies whether all are false. In the case where all are false, it returns a return value of a positive integer representing such fact. Next, the network library 405e reads the attribute information file of the content of the identifier indicated by the argument cid, by requesting the IO 405g. Next, the network library 405e checks the value of a member variable RestrictRecordDevice of the DecisionPolicy class. In the case where this value is true, the network library 405e checks the RecordRequest element from the attribute information file. Subsequently, in the case where it is judged that there is no RecordRequest element, or that by comparing such value and the value of the argument dev, it is judged that it not the same device, the network library 405e returns a return value which is a positive value representing such fact. Next, the network library 405e checks the Protected element of the attribute information file, and judges that outputting is possible and returns 0, in the case where there is no Protected element or the value thereof is not “Yes”. In the case where the value of the Protected element is “Yes”, judgment is sequentially performed according to the values of the member variables of the DecisionPolicy class. In the case where the variable askHeadend is true, the network library 405e transmits the member variable deviceID of the argument cid and the argument dev to the broadcast station 106, and receives a possible/not possible judgment. Furthermore, in the case where the variable askServer is true, the network library 405e transmits the member variable deviceID of the argument cid and the argument dev to the external server, and receives a possible/not possible judgment. Furthermore in the case that the member variable askApplication is true, the network library 405e calls the method queryExposePermission( ) of the set ServHandler interface. Furthermore, in the case where the member variable referCCI is true, the network library 405e refers to the CCI obtainable from a CableCARD, and the like, and judges outputting to be possible when outputting to the outside is permitted. The CCI may be stored in advance, as attribute information, in the second memory 203 during storing. Furthermore, in the case where the member variable referEmbeddedCCI is true, the network library 405e refers to the CCI embedded in the multimedia data, and judges outputting to be possible when outputting to the outside is permitted. The CCI may be stored in advance, as attribute information, in the second memory 203 during storing. Furthermore, in the case where a plurality among the askHeadend, askServer, askApplication, referCCI, and referEmbeddedCCI are set as true, outputting may be judged as possible only when it is judged that outputting is possible for all thereof, and outputting may also be judged as possible when it is outputting is judged as possible according to any one condition. Alternatively, it is also possible to assign priorities thereto, and assume that outputting is possible when outputting is judged as possible in a member variable with the higher priority. According to the aforementioned process, the method judgeExpose( ) returns 0 in the case where it is judged that outputting is possible and, in the case where it is judged that outputting is not possible, returns a positive value representing the reason therefor. Furthermore, in the case where some sort of trouble occurs, such as when connection with the external server is not possible, and so on, method judgeExpose( ) returns an error code which is a negative value.

The content searching unit 1703 searches out a content that matches the provided condition, from among the contents stored in the second memory 203.

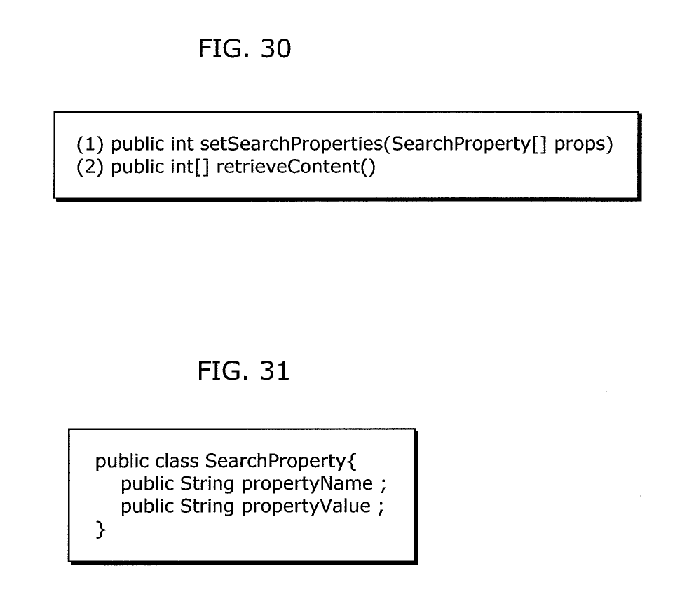

The content searching unit 1703 provides a lava API to the control unit 1701 and the downloaded Java application. FIG. 30 is an example of the Java API provided by the content searching unit 1703. The method setSearchProperties( ) in FIG. 30(1) sets a search condition provided by an argument props, and returns 0 when successful, and returns an error code which is a non-0 value in the case of a failure. The argument props is the arrangement of instances of the SearchProperty class. FIG. 31 shows an example of the SearchProperty class. In FIG. 31, a member variable propertyName of the SearchProperty class is a string variable storing a character string which is a name of a property included in a UPnP AV Search request. Furthermore, a member variable propertyValue is a string variable storing a character string which is a value of the property. These are set by the message processing unit 1704 described later, by analyzing the Search request and Browse request.

Furthermore, a method retrieveContent( ) in FIG. 30(2) searches for a content according to the condition set by the method setSearchProperties( ). The method retrieveContent( ) returns the arrangement of the identifiers or the contents which have been picked out when the search is successful, and returns null in the case of failure. Hereinafter, such process shall be described. When this method is called, the network library 405e first returns, as the arrangement, the identifiers of all contents for which outputting is permitted, from among the contents stored in the second memory 203, in the case where a condition is not set by the method setSearchProperties( ). The contents for which outputting is permitted are contents that do not have an Expose element in the attribute information file, or have an Expose element with a value of “allowed” The network library 405e obtains the identifiers of such contents from the ContentID element, and returns the obtained identifiers by setting them in an arrangement. In the case where a condition is set, searching is performed by referring to the attribute information file of each content. First, it is judged, in the same manner, whether or not outputting is permitted. In the case where outputting is permitted, it is checked whether or not the condition is matched. Hereinafter, this process shall be described using an MPEG transport stream as an example. In the case where upnp:class is set as the property name and object.item.videoItem.protectedTSVideo is set as a value, the network library 405e judges, based on the attribute information file, whether or not a content matches. In particular, it is judged from the Format element and the Protected element. In this case, a content having “MPEG2-TS” as the value of the FormatType and having a Protected element with a value of “Yes” fits the category. In the case of a fit, the identifier of the content is read from the attribute information file, and this is set. Furthermore, in the case where upnp:class is set as the property name and object.item.videoItem.TSVideo is set as a value, a content having “MPEG2-TS” as the value of the FormatType, and which does not have a Protected element or has a Protected element but with a value that is not “Yes” fits the category. In the case of a fit, the identifier of the content is read from the attribute information file, and this is set. The search is performed for other conditions, using the same process.

The message processing unit 1704 analyzes a request message received via the network 104, and generates a reply message.

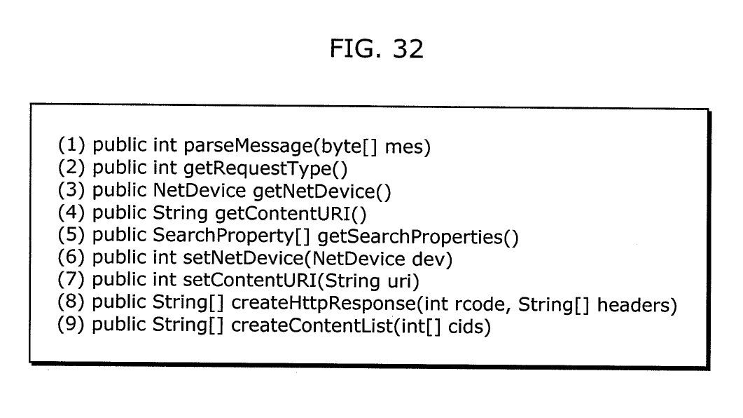

The message processing unit 1704 provides a lava API to the control unit 1701 and the downloaded lava application. FIG. 32 is an example of the lava API provided by the message processing unit 1704. A method parseMessage( ) in FIG. 32(1) analyzes the request message provided by an argument mes which is a byte-type arrangement. The method parseMessage( ) returns 0 when successful, and returns a non-0 error code in the case of failure. Data provided by the argument mes is data received by the transmitting and receiving unit 1705 to be described later.

A method getRequestType( ) in FIG. 32(2) returns the type of a successfully analyzed request message. It returns a positive value representing the type when successful, and returns an negative value error code in the case of failure. In the present embodiment, 1 is returned in the case of a Browse request, 2 is returned in the case of a Search request, and 3 is returned in the case of a transmission request for multimedia data.

A method getNetDevice( ) in FIG. 32(3) returns, using an instance of the NetDevice class, information on the transmission-source terminal, which is read from the message. The method getNetDevice( ) returns null when reading is unsuccessful or in the case of failure.

A method getContentURI( ) in FIG. 32(4) returns the URI of the content requested in the message, using a String instance, and returns null when reading is unsuccessful or in the case of failure. In this method, a valid value is returned only in the case where the request message is a multimedia data transmission request.

A method getSearchProperties( ) in FIG. 32(5) returns a search condition included in the message, using the arrangement of instances of the SearchProperty class.

A method setNetDevice( ) in FIG. 32(6) sets a NetDevice instance provided by the argument dev, as information on the device to be included in the reply message. It returns 0 when successful and returns an error code which is a non-0 value in the case of failure.

A method setContentURI( ) in FIG. 32(7) sets a character string provided by a String argument uri, as the content URI to be included in the reply message. It returns 0 when successful and returns an error code which is a non-0 value in the case of failure.

A method createHttpResponse( ) in FIG. 32(8) generates the header of an HTTP response to be sent back, according to the response code of the HTTP provided by an argument rcode and an extension header provided by an argument headers, and returns this using an arrangement of a String variable. The method createHttpResponse( ) returns null in the case of failure.

A method createContentList( ) in FIG. 32(9) generates a list-format message to be sent back, for the collection of contents provided by an argument cids which is an arrangement of content identifiers, and returns the message using an arrangement of String variables. The method createContentList( ) returns null in the case of failure. This method reads the attribute information file of each content provided by the argument cid, extracts necessary information and generates a message. Note that in the search and extraction by the content searching unit 1703, information necessary for generating a content list is extracted and kept as an arrangement. This method may also assume the format in which such arrangement is provided as an argument.

The transmitting and receiving unit 1705 controls the network unit 211 through the NET 401b4 inside the library 401b of the OS 401, accepts a connection request from a specified external device connected to the network 104, and carries out the transmission and reception of messages.

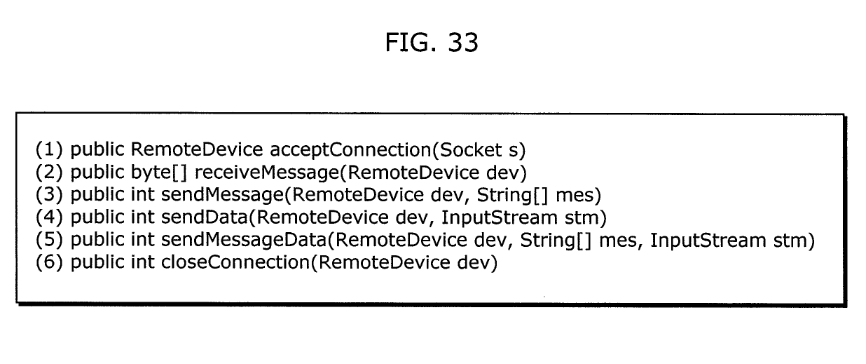

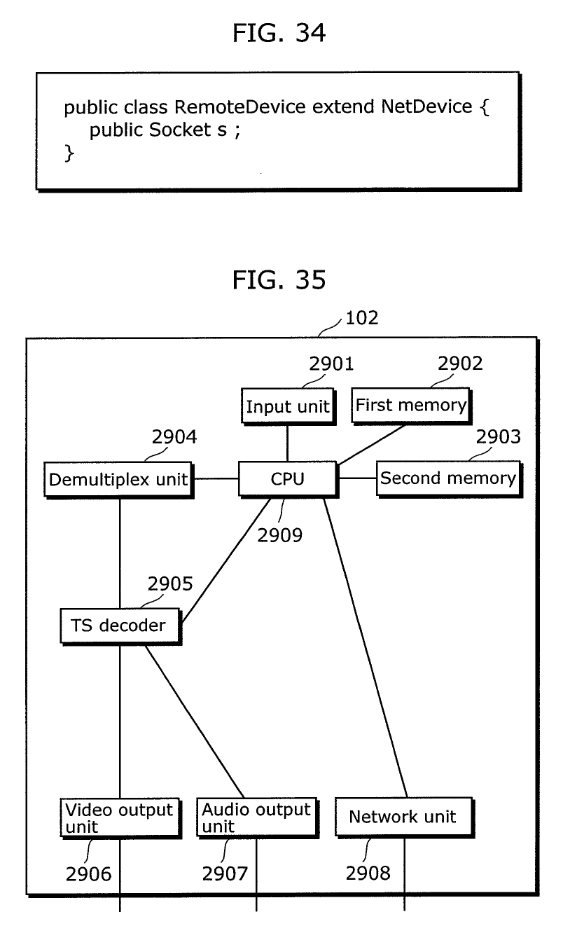

The transmitting and receiving unit 1705 provides a Java API to the control unit 1701 and the downloaded Java application. FIG. 33 is an example of the Java API provided by the transmitting and receiving unit 1705. A method acceptConnection( ) in FIG. 33(1), according to the Socket object provided by the argument s, goes on standby for an external device, establishes a connection with the requesting device, and returns information on the device as well as a RemoteDevice object including a Socket object communicating with the device. It returns the RemoteDevice object when successful, and returns null in the case of failure. FIG. 34 shows an example of a RemoteDevice class. In FIG. 34, the RemoteDevice class is an extension class of the NetDevice class, which holds information on a socket for which a connection has been established, using a Socket-type member variable s. In the process for this method, for example, in the case where a connection request for an HTTP session is received from a terminal, it is possible to generate a RemoteDevice object from the Socket object for transmitting/receiving an HTTP message and the IP address of the requesting terminal. Note that this method may be further provided with an arrangement of the NetDevice objects as an argument, and respond only to a connection request from a device indicated by the respective components of the arrangement. Furthermore, it is also possible that in the present method, the arrangement of the NetDevice objects is likewise provided as an argument and, in the case of a connection request from a device indicated by the respective components of the arrangement, the RemoteDevice object is generated from the Socket object communicating with the corresponding NetDevice.

A method receiveMessage( ) in FIG. 33(2) receives a message from a device provided by the argument dev, using a Socket object included in the argument dev, and returns this as an arrangement of byte data. It returns a byte sequence when successful, and returns null in the case of failure.

A method sendMessage( ) in FIG. 33(3) sends a message provided by the argument mes to the device provided by the argument dev. The method sendMessage( ) returns 0 when successful, and returns a non-0 error code in the case of failure.

A method sendData( ) in FIG. 33(4) reads data from an InputStream instance provided by an argument stm and at the same time sends the read data to the device provided by the argument dev. The method sendData( ) returns 0 when successful, and returns a non-0 error code in the case of failure. Failure refers to, for example, the case where network connection is cut-off midway through transmission, the case where the InputStream is closed midway during reading, and the like.

A method sendMessageData( ) in FIG. 33(5) sends a message provided by the argument mes to the device provided by the argument dev, and consecutively, reads data from an InputStream instance provided by the argument stm and at the same time sends the read data. The method sendMessageData( ) returns 0 when successful, and returns a non-0 error code in the case of failure. This method is used mainly in the case of transmitting multimedia data in HTTP.

A method closeConnection( ) in FIG. 33(6) closes the network connection established with the device provided by the argument dev. It returns 0 when successful, and returns a non-0 error code in the case of failure.

Here, details of the operation of the method actMultimediaServer( ) of the control unit 1701 shall be described. When the present method is called, the network library 405e first calls the collectDevice( ) and carries out recognition of a device connected to the network. Furthermore, the network library 405e generates a Socket object and goes on standby for a communication defined in the UPnP DA or UPnP AV. This is performed by generating a different thread or process. With this, communication defined in the UPnP DA is performed and the list of connected devices is updated as necessary.

When the registerHandler( ) of the control unit 1701 is called by the Java application, the network library 405e calles the method registerHandler( ) of the judgment unit 1702 and performs the setting of a call back handler, as necessary.

When notified of the acceptance of the connection from a device connected to the network, through the method acceptConnection( ) of the transmitting and receiving unit 1705, the network library 405e then receives a request message using the method receiveMessage( ) of the transmitting and receiving unit 1705. In addition, the network library 405e provides the received message to the message processing unit 1704, and causes it to perform analysis through the method parseMessage( ). Furthermore, network library 405e obtains the type of the request message through the method getRequestType( ).

In the case where the request message is a Browse request or a Search request, the network library 405e obtains the search conditions through the method getSearchProperties of the message processing unit 1704. Subsequently, the network library 405e calls the method setSearchProperties( ) of the content searching unit 1703, and sets the search conditions. Next, the network library 405e calls the method retrieveContent( ) of the content searching unit 1703, causes it to carry out the content search, and obtains a collection of contents.

Next, the network library 405e calls the method setDecisionPolicy( ) of the judgment unit 1702 and sets the judgment policy. In addition, the network library 405e provides each of the contents extracted by the content searching unit 1703 to the method judgeExpose( ) of the judgment unit 1702, causes it to perform judgment as to whether or not transmission is possible, and obtains the collection of contents that can be transmitted. Note that the network library 405e may set the policy regarding the judgment of the judgment unit 1702 before the content searching, and the content searching unit may perform judgment on each of the selected contents by calling the method judgeExpose( ) of the judgment unit 1702, and return the collection of contents that are judged to be transmittable.

Next, the network library 405e calls the method createContentList( ) of the message processing unit 1704, and generates a content list reply message. In addition, the network library 405e calls the method sendMessage( ) of the transmitting and receiving unit 1705 and transmits the generated content list.

In the case where the received request message is an HTTP-GET for a content, that is, a transmission request for content data, the network library 405e calls the method getContentURI( ) of the message processing unit 1704 and obtains the URI of the content. Next, the network library 405e reads the URI table 1331 by requesting the IO 405g and, by comparing the content URI, obtains the identifier of the requested content. Next, the network library 405e reads the attribute information table 1321 by requesting the IO 405g, and obtains the file name of the attribute information file of the content for the identifier. Next, the network library 405e reads the attribute information of the file name by requesting the IO 405g, and obtains the file name of the content. Next, the network library 405e obtains an InputStream instance which reads the content data of the file name, by requesting the IO 405g.

In addition, the network library 405e sets the information of the content information outputting apparatus 101 into the method setNetDevice( ) of the message processing unit 1704. Furthermore, the network library 405e provides and sets the URI of the content to be sent back, into the method setContentURI( ) of the message processing unit 1704. In addition, when there is an HTTP extension header necessary for replying, the network library 405e: generates such extension header; provides 200, indicating OK, as an HTTP response code, as well as the generated extension header to the method createHttpResponse( ) of the message processing unit 1704; and generates the header of the HTTP response message.

Next, the network library 405e provides, to the method sendMessageData( ) of the transmitting and receiving unit 1705, the header of the HTTP response message generated by the message processing unit 1704 and the InputStream instance obtained from the IO 405g, calls the transmitting and receiving unit 1705 and transmits the multimedia.

Note that in the case where trouble occurs, such as when the content of the requested URI does not exist, the network library 405e causes the message processing unit 1704 to generate an error message in accordance with such trouble, and transmits this through the method sendMessage( ) of the transmitting and receiving unit 1705.

Furthermore, when the method setDecisionPolicy( ) of the judgment unit 1702 is called by the Java application, the network library 405e reflects this in the setting of the judgment policy of the judgment unit 1702. Note that the policy regarding judgment need not be set by the Java application as in this case, and it may also be set from the broadcast station 106, a server specified by the content rights holder, and so on.

Next, the content information receiving apparatus 102 shall be described.

FIG. 35 is a block diagram showing the relationship of constituent elements of the content information receiving apparatus 102 in the present embodiment. The content information receiving apparatus 102 includes an input unit 2901, a first memory 2902, a second memory 2903, a demultiplex unit 2904, a TS decoder 2905, a video output unit 2906, an audio output unit 2907, a network unit 2908, and a CPU 2909.

Note that the functions of the Java execution unit 4101, the transmitting and receiving unit 4102, the message processing unit 4103, and the search condition setting unit 4104 are implemented through the execution, by the CPU 2909, of a program stored in the second memory unit 2903.

The input unit 2901, the first memory 2902, and the second memory 2903 are identical to the input unit 201, the first memory 202, and the second memory 203 of the previously described content information outputting apparatus 101 in the present embodiment. Note that the content information receiving apparatus 102 stores, in the second memory 2903, program information such as the identifier, title, broadcast date and time, broadcast channel, and so on, of the multimedia data in the content list, EPG data, and so on, received from the content information outputting apparatus 101.

The demultiplex unit 2904 receives an MPEG transport stream from the CPU 2909, extracts information specified by the CPU 2909 and passes the extracted information to the CPU 2909. In addition, demultiplex unit 2904 passes the MPEG transport stream directly to the TS decoder 2905.

The TS decoder 2905 receives identifiers of audio data, video data from the CPU 2909. In addition, the TS decoder 2905 extracts data corresponding to the received identifiers of audio data and video data, from the stream received from the demultiplex unit 2904. The TS decoder 2905 passes extracted video data to the video output unit 2906, and audio data to the audio output unit 2907.

The video output unit 2906 and the audio output unit 2907 are identical to the video output unit 208 and the audio output unit 209, respectively, of the previously described content information outputting apparatus 101 in the present embodiment.

The network unit 2908, which includes a network interface, converts the data received from the CPU 2909 into a signal that is in accordance with the physical media of the network to which the network interface is connected to, and outputs this signal. Furthermore, the network unit 2908 receives a signal from the network interface, converts the signal into a packet defined by the IP network, and passes the packet to the CPU 2909.

The CPU 2909 controls the demultiplex unit 2904, the TS decoder 2905, and network unit 2908, by executing a program stored in the second memory 2903.

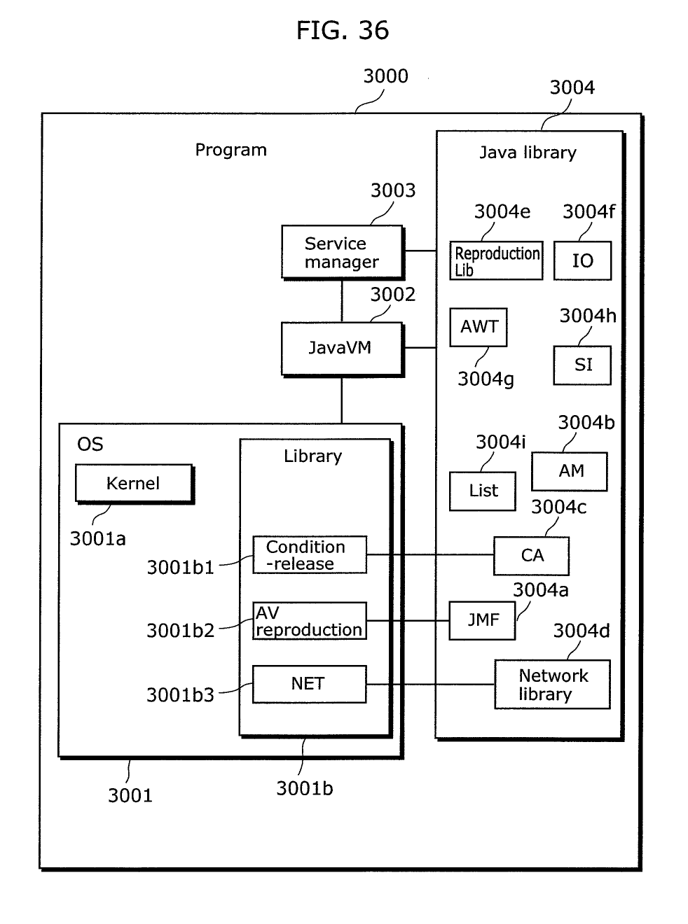

FIG. 36 is an example of a structure diagram of the program stored in the second memory 2903 and executed by the CPU 2909.

A program 3000 is made up of a plurality of subprograms and specifically includes an OS 3001, a Java VM 3002, a service manager 3003, and a Java library 3004.

The OS 3001 is a subprogram activated by the CPU 2902 when power to the content information receiving apparatus 102 is turned on. OS stands for operating system, an example of which is Linux and the like. The OS 3001 is a generic name for publicly known technology made up of a kernel 3001a for executing another subprogram concurrently, and of a library 3001b, and therefore detailed description is omitted. In the present embodiment, the kernel 3001a of the OS 3001 executes the Java VM 3002 as a subprogram. Furthermore, the library 3001b provides these subprograms with plural functions required for controlling the constituent elements held by the content information receiving apparatus 102.

In the present embodiment, the library 3001b includes condition-release 3001b1, AV reproduction 3001b2, and NET 3001b4, as an example of functions.

The condition-release 3001b1 receives information from other subprograms and a CA 3004c of the Java library 3004, decrypts encrypted data received from the network, enables the AV reproduction 3001b2, and permits the reproduction of the multimedia data received from the network.

The AV reproduction 3001b2 receives an audio packet ID and video packet ID from the other subprograms and a JMF 3004a of the Java library 3004. It then provides the received audio packet ID and video packet ID to the TS decoder 2905. As a result, the TS decoder 2905 performs filtering based on the provided packet IDs, and implements the reproduction of audio/video.

The NET 3001b3 creates packets of a protocol lower than the application level defined in the IP network, for the data received from the other subprograms and a network library 3004d of the Java library 3004. A protocol lower than the application level refers to, for example, a TCP packet, a UDP packet, an IP packet, and so on. By passing this to the network unit 2908, messages and data are transmitted to another device via the network 104. Furthermore, when a message is received from another device via the network 104, the NET 3001b3 converts the message to an application level protocol packet and passes this to the other subprograms and the network library 3004d of the Java library 3004. An application level protocol refers to, for example, HTTP, RTSP, RTP, and so on.

The Java VM 3002 is identical to the Java VM 403 of the previously described content information outputting apparatus 101 in the present embodiment.

The service manager 3003 is identical to the service manager 404 of the above-described content information outputting apparatus 101 in the embodiment, except in the following point. The service manager 404 receives a channel identifier from the reproduction unit 402b of the EPG 402; passes the identifier to the Tuner 405c and causes the Tuner 405c to perform tuning; performs descrambling by requesting the CA 405d, and requests the reproduction of video and audio by providing the channel identifier to the JMF 405a. Whereas, the service manager 3003 receives the content identifier from a List 3004i inside the Java library 3004; passes the content identifier as well as information on the apparatus storing such content identifier, and so on, to the network library 3004d and receives a stream from the apparatus; then requests for the reproduction of video and audio by providing the content identifier to the JMF 3004a inside the Java library 3004. The List 3004i shall be described later.

The service manager 3003 provides, to the network library 3004d inside the Java library 3004, information such as the content identifier and the IP address of content information outputting apparatus 101, and information such as the URI for accessing the content; requests the content information outputting apparatus 101 for the issuance of a multimedia data transmission request and the reception of the multimedia; and in addition requests the network library 3004d to receive the multimedia data transmitted from the content information outputting apparatus 101. Upon receiving the request, the network library 3004d connects to the content information outputting apparatus 101, and issues a transmission request for the multimedia data. Subsequently, the network library 3004d passes the data transmitted by the content information outputting apparatus 101 to the CPU 2902. With this, it is possible to pass the received multimedia data to the demultiplex unit 2904 and carry out the reproduction of the multimedia data.

The Java library 3004 is a collection of plural Java libraries stored in the second memory 2903. In the present embodiment, the Java library 3004 includes the JMF 3004a, an AM 3004b, the CA 3004c, the network library 3004d, a reproduction Lib 3004e, and the List 3004i.

The JMF 3004a, the AM 3004b, the reproduction Lib 3004e, an IO 3004f, an AWT 3004g, a SI 3004h are identical to the JMF 405a, the AM 405b, the reproduction Lib 405f, the IO 405g, the AWT 405h, and the SI 405i, respectively, which are located inside the Java library 405 of the previously described content information outputting apparatus 101 in the present embodiment.

The CA 3004c manages rights processing of multimedia, such as the copy control for the multimedia transmitted via the network 104. Information for copy control may be transmitted from content providers such as the content information outputting apparatus 101 and broadcast station 106, and an external server specified by the rights holder, and may also be referred to from copy control information included in the PMT of a transport stream transmitted from a content information outputting apparatus.

The List 3004i displays an EPG of the content information outputting apparatus 101 or a list of multimedia contents stored and provided by the content information outputting apparatus 101, selects one multimedia content from the list according to a user's operation accepted by the input unit 2901, and requests reproduction to the service manager 3003. At this time, information on the content information outputting apparatus 101 is also passed to the service manager 3003. Furthermore, the EPG of the content information outputting apparatus 101 and the list of contents provided by the content information outputting apparatus 101 can be obtained through the network library 3004d. Note that the List 3004i may also be included in the network library 3004d.

The network library 3004d communicates with the content information outputting apparatus 101 connected to the network 104, through the NET 3001b3 of the OS 3001. The communication with the content information outputting apparatus 101 includes multimedia data list transmission/reception, multimedia data transmission request issuance and receiving of the multimedia data.

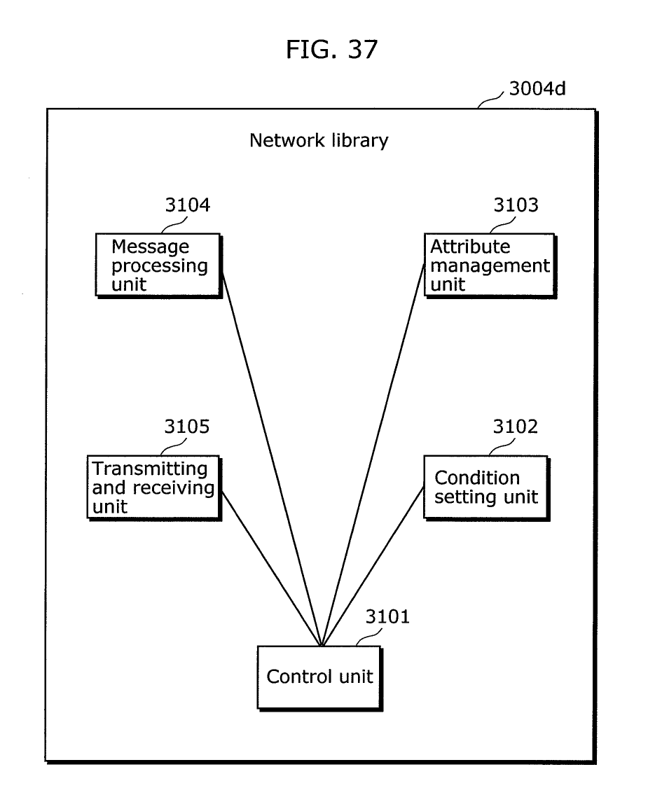

FIG. 37 is a block diagram showing an example of the internal configuration of the network library 3004d. The network library 3004d includes a control unit 3101, a condition setting unit 3102, an attribute management unit 3103, a message processing unit 3104, and a transmitting and receiving unit 3105. Note that the network library 3004d may also include other functions related to the IP network.

The control unit 3101 provides, to a downloaded Java application, the function for implementing the network library 3004d. In other words, the control unit 3101 can execute a network-using function by providing a Java API to the Java application, and by the Java application calling such API. When the Java API is called, the control unit 3101 performs processes using the condition setting unit 3102, the message processing unit 3104, the transmitting and receiving unit 3105, and the rest of the Java library 3004 and the library 3001b of the OS 3001, as necessary.

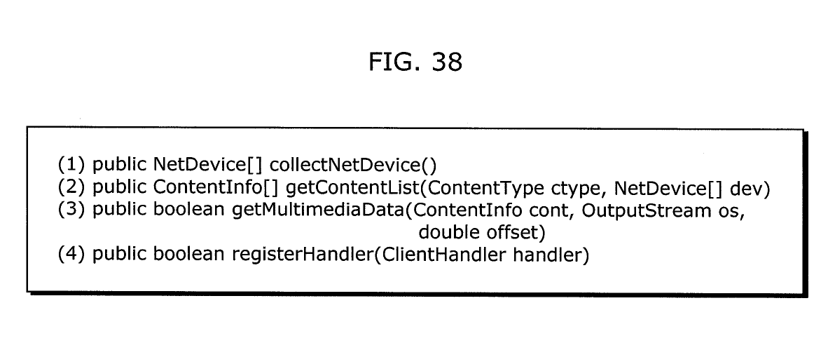

FIG. 38 is an example of the Java API provided by the control unit 3101. A method collectDevice( ) in FIG. 38(1) collects information on other devices connected to the network 104, and returns, as such information, the arrangement of NetDevice objects. It returns null in the case of failure. With this method, it is possible to obtain information on the device connected to the network 104. The NetDevice class is identical to that shown in FIG. 24. Since the process for this method can be carried out according to the method defined in UPnP DA, detailed description shall be omitted.

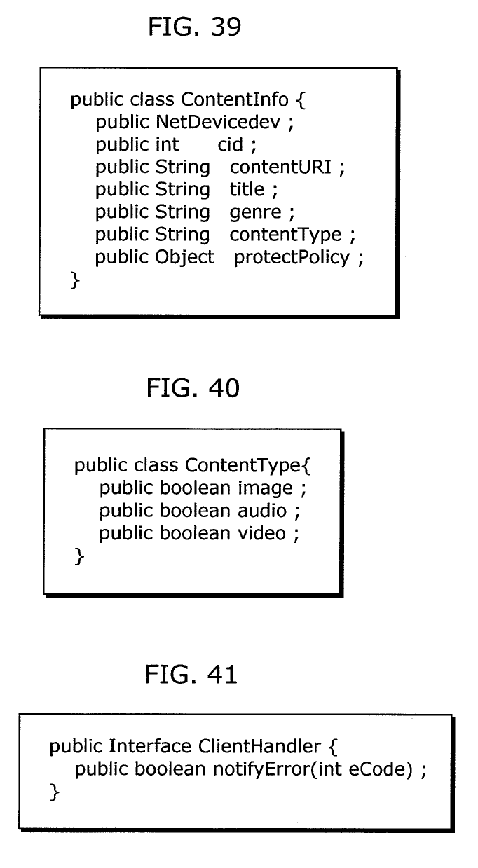

A method getContentList in FIG. 38(2) obtains a list of contents of the type provided by an argument ctype, from a multimedia server connected to the network 104, which is provided by the argument dev. When successful, the method getContentList returns the content list using an arrangement of instances of a ContentInfo class, and returns null in the case of failure. The argument dev is an arrangement of a NetDevice instances and the setting of plural multimedia servers is possible. In the case where the argument dev is null, the network library 3004d obtains a content list from all multimedia servers connected to the network 104. FIG. 39 shows an example of the ContentInfo class. In FIG. 39, the ContentInfo class is made up of seven member variables. A member variable dev is an instance of the NetDEvice class and indicates the multimedia server providing the content. A member variable cid indicates the identifier of the content. A member variable contentURI indicates the URI for obtaining multimedia data of the content. A member variable title indicates the title of the content. In the case where there is no tite, the member variable title shows null. A member variable genre indicates the genre of the content. This becomes null in the case where the genre is not set. A member variable contentType indicates the type of the content, and indicates a Content-Type assigned to the media format of the content by the IANA. A member variable protectpolicy indicates the protection method required by the content. A character string representing the protection technique name is used therein. Note that the details adopted by the member variable contentType need not be the Content-Type, and may be anything that can identify the type of the content, such as MPEG2-TS, and JPEG. Furthermore, FIG. 40 shows an example of the ContentType class. In FIG. 40, the ContentType class is made up of three boolean member variables. When a member variable image is set to true, a still-picture content request is issued; when set to false, a still-picture request is not issued. When a member variable audio is set to true, a music content request is issued; when set to false, a music content request is not issued. When a member variable video is set to true, a video content request is issued; when set to false, a video content request is not issued. Note that the ContentType class may be segmented on a media format basis such as JPEG, MP3, MPEG2-TS. In this manner, when the multimedia server and the requested content type are forwarded, the network library 3004d transmits a Browse request or Search request to the forwarded multimedia server, obtains a content list and returns this. Details of this process shall be described later.

A method getMultimediaData( ) in FIG. 38(3) receives the multimedia data provided by the argument cont, from the position provided by the argument offset, and outputs this to an OutputStream object provided by the argument os. The argument os performs the role of passing received multimedia data to the CPU 2909. The argument offset provides a position in a content with the beginning as 0. Furthermore, in the case where the starting point is not specified, a value of 0 or less is provided for the argument offset. The content position may be a byte position of the content data, and may be a unit of time such as seconds. Note that in the present embodiment, although only the starting point is provided by an argument, it is also possible to add an argument and likewise provide the temporal position of the ending point. In this case, when the ending point is not specified, it may be implemented by providing a negative number for the argument. The argument cont is provided as an object of the ContentInfo class.

A method registerHandler( ) in FIG. 38(4) registers, into the system, a ClientHandler interface-equipped object which is provided through an argument handler. It returns true when successful and false in the case of a failure. By registering the object as a handler, the Java application can receive a callback from the network library 3004d. FIG. 41 shows an example of the structure of the ClientHandler interface. In FIG. 41, a method notifyError( ) of the ClientHandler notifies the occurrence of an error to the Java application, using an error code provided by an argument eCode. By notifying the error, the Java application can present this to the user.

The condition setting unit 3102 generates, during the issuing of a content list transmission request to the multimedia server, conditions therefor.

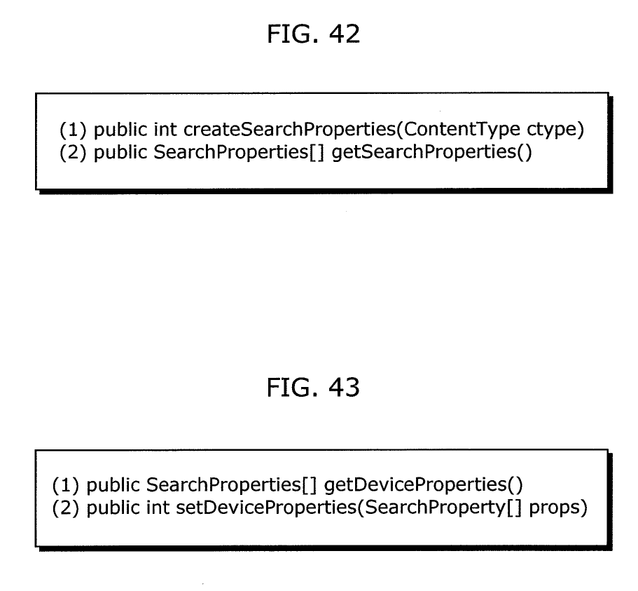

The condition setting unit 3102 provides a Java API to the network library 3004d and the downloaded Java application. FIG. 42 is an example of the Java API provided by the condition setting unit 3102. A method createSearchProperties( ) in FIG. 42(1) generates a search condition for the content type provided by the argument ctype. It returns 0 when successful, and returns an error code which is a non-0 value in the case of a failure. The argument ctype is an instance of the previously described ContentType. Details of this process shall be described later.

A method getSearchProperties( ) in FIG. 42 returns the search conditions generated by the method createSearchProperties( ) through an arrangement of SeachProperties instances. It returns null in the case where the search condition generation fails.

The attribute management unit 3103 manages the attributes of the content information receiving apparatus 102. Attributes refer to the corresponding media format, the presence/absence of rights to use protected video content, the type of the corresponding content protection technique, and so on. These attributes are stored in the second memory 2903.

The attribute management unit 3103 provides a lava API to the network library 3004d and the downloaded Java application. FIG. 43 is an example of the lava API provided by the attribute management unit 3103. A method getDeviceProperties( ) in FIG. 43(1) returns the attributes of the content information receiving apparatus 102 through an arrangement of SeachProperty instances. It returns false in the case where the search condition generation fails. When this method is called, the network library 3004d reads the attributes of the content information receiving apparatus 102 from the second memory 2903, by requesting the IO 3004f. Subsequently, the network library 3004d generates the arrangement of the SearchProperty instances from the attributes and returns this. Note that when the right to use protected video content is possessed, the property name is assumed as the DeviceID, and the value thereof must include the property which is the identifier of the content information receiving apparatus 102 issued by the broadcast station 106 or the content rights holder.

A method setDeviceProperties( ) in FIG. 43(2) sets the arrangement of SeachProperty instances provided by the argument prop as the attributes of the content information receiving apparatus 102. When this method is called, the network library 3004d converts the provided arrangement of SeachProperty instances into the format of the attributes of the content information receiving apparatus 102 and, in addition, stores this in the second memory 2903, by requesting the IO 3004f. With this, it is possible to carry out the conversion of attributes, for example, in the case where use rights for protected video content is newly obtained, or in the case where a software decoder for the multimedia data is downloaded and the corresponding media format changes, and so on. Note that although in the present embodiment, all attributes are rewritten, it is also possible to change attributes by preparing a method which adds or a method which cancels an attribute. In addition, although a new attribute is stored in the second memory 2903, it is also possible to prepare a method for instructing the storing, and to not carry out storing in the second memory 2903 until such method is called. According to this configuration, it becomes possible to handle, for example, a case where a software decoder is downloaded only for temporarily use and the software decoded is discarded after use.

The message processing unit 3104 analyzes a request message received via the network 104, and generates a reply message.

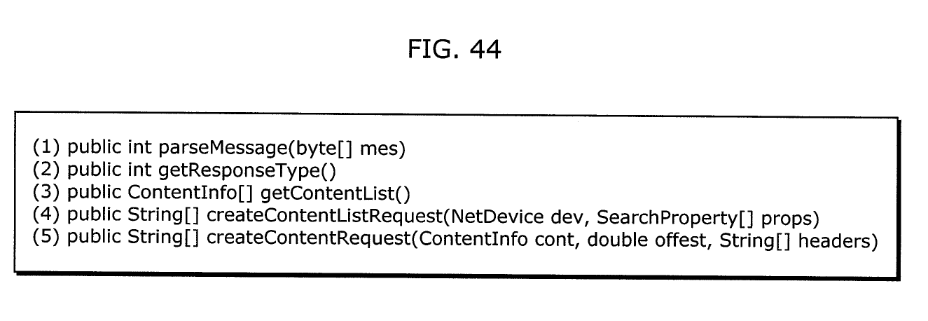

The message processing unit 3104 provides a Java API to the control unit 3101 and the downloaded Java application. FIG. 44 is an example of the Java API provided by the message processing unit 3104. A method parseMessage( ) in FIG. 44(1) analyzes the request message provided by an argument mes which is a byte-type arrangement. The method parseMessage( ) returns 0 when successful, and returns a non-0 error code in the case of failure. Data provided by the argument mes is data received by the transmission/reception unit 3105 to be described later. In the case where the message is a content list, method parseMessage( ) analyzes the content list, generates an arrangement of ContentInfo instances and stores the content list therein.

A method getResponseType( ) in FIG. 44(2) returns the type of a successfully analyzed received message. It returns a positive value representing the type when successful, and returns an negative value error code in the case of failure. In the present embodiment, 1 is returned in the case where the received message is a content list, and in the case of an HTTP response header, a response code thereof is returned.

A method getContentInfo( ) in FIG. 44(3) returns an arrangement of the ContentInfor instances generated from the analyzed content list. It returns null when the content could not be read or in the case of failure.

A method createConentListRequest( ) in FIG. 44(4) creates the message for the content list transmission request to the multimedia server provided by the argument dev. The method createConentListRequest( ) generates a Browse request or a Search request with the arrangement of SearchProperty instances provided by the argument prop as search conditions. This method returns the created message using an arrangement of Sting variables, and returns null in the case of failure.

A method createConentRequest( ) in FIG. 44(5) generates a multimedia transmission request message for the content provided by the argument cont, for the multimedia server provided by the argument dev. The method createConentRequest( ) returns the generated message using an arrangement of String variables, and returns null in the case of failure. Since HTTP is used as the content transmission protocol, the generated message is HTTP-GET. The multimedia server to which the request is to be sent can be obtained from the member variable dev of the argument cont. Furthermore, the URI of the requested content can be obtained from the member variable content URI of the argument cont. The argument offset provides a position in the content, with the beginning as 0. Furthermore, in the case where the starting point is not specified, a value of 0 or less is provided for the argument offset. The content position may be a byte position of the content data, and may be a unit of time such as seconds. In the case of a byte position, this can be implemented through an HTTP Range header. Furthermore, in the case where a temporal position is specified, a TimeSeekRange.dlna.org header defined by the DLNA can be used. Furthermore, the argument headers provides, in the case where there is an extension header to be added, such extension header. Note that in the present embodiment, although only the starting point is provided by an argument, it is also possible to add an argument and likewise provide the temporal position of the ending point. In this case, when the ending point is not specified, it may be implemented by providing a negative number for the argument.

The transmitting and receiving unit 3105 controls the network unit 2908 through the NET 3001b3 of the library 3001b of the OS 3001, and performs the connection with the specified external device connected to the network 104 as well as the transmission and reception of messages and data.

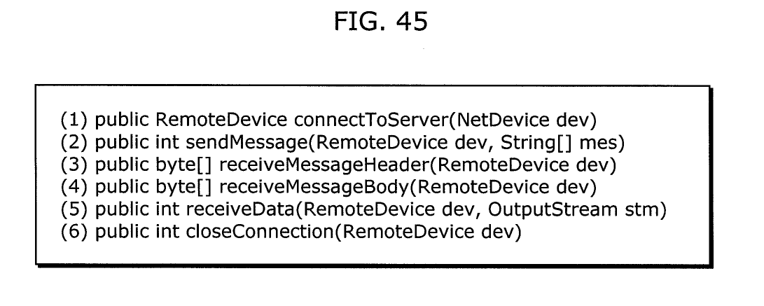

The transmitting and receiving unit 3105 provides a Java API to the network library 3004d and the downloaded Java application. FIG. 45 is an example of the Java API provided by the transmitting and receiving unit 3105. A method connectToServer( ) in FIG. 45(1) creates a Socket object s; establishes a TCP session with the device provided by the argument dev using the Socket object s; generates a RemoteDevice object using the Socket object s and the details of the argument dev and returns the generated this. The method connectToServer( ) returns the RemoteDevice object when successful, and returns null in the case of failure. The structure of the RemoteDevice class is identical to that shown in FIG. 34. Communication of messages and multimedia data is carried out in this TCP session.

A method sendMessage( ) in FIG. 45(2) transmits data provided by the argument mes to the external device provided by the argument dev, using the Socket object provided by the argument dev. The method sendMessage( ) returns true when successful, and returns false in the case of failure.

A method receiveMessageHeader( ) in FIG. 45(3) receives, using a Socket object provided by the argument dev, the header of the message sent from a device provided by the argument dev, and returns a byte sequence of received data. It returns null in the case of failure. Note that UPnP uses Simple Object Access Protocol (SOAP) and, in SOAP, message transmission and reception is generally performed using HTTP. For this reason, in the present method, an HTTP response header is received in both the reception of messages and in the reception of multimedia data.

A method receiveMessageBody( ) in FIG. 45(4) receives, using a Socket object provided by the argument dev, the details of the message sent from a device provided by the argument dev, and returns a byte sequence of the received data. It returns null in the case of failure. This method is used for receiving a UPnP message contained in the body of an HTTP response.

A method receiveData( ) in FIG. 45(5) receives, using a Socket object provided by the argument dev, data sent from a device provided by the argument dev, and outputs the received data to an OutputStream object provided by the argument stm. The method receiveData( ) returns 0 when successful and returns a non-0 value, which is an error code, in the case of failure. The received data is not outputted after its entirety is received but is sequentially outputted while being received. Failure refers to, for example, the case where TCP connection is cut-off midway through transmission.

A method closeConnection( ) in FIG. 45(6) closes the network connection established with the device provided by the argument dev. It returns 0 when successful, and returns a non-0 error code in the case of failure.

Here, the operation of the method getContentList( ) of the control unit 3101 shall be described in more detail. When this method is called, first, the network library 3004d calls the method createSearchProperties( ) of the condition setting unit 3102 and generates search conditions, by providing the ContentType provided by the argument ctype for the argument. When the generation of the search conditions is successful, the network library 3004d then calls the method getSearchProperties( ) of the condition setting unit 3102 and receives the generated search conditions through an arrangement of SearchProperties instances.

In addition, the network library 3004d performs the following processing on all components of the arrangement of NetDevice objects provided by the argument dev. Here, the NetDevice object to be subject to processing is assumed as dev1. The network library 3004d calls the method createContentListRequest( ) of the message processing unit 3104, by providing the received arrangement of SearchProperties instances and the value of dev1 as an argument. Subsequently, the network library 3004d receives a content list transmission request message as a return value. Next, by providing the value of dev1 as an argument, the network library 3004d calls the method connectToServer of the transmitting and receiving unit 3105, establishes a TCP connection with the multimedia server, and receives the RemoteDevice object as a return value. The received RemoteDevice object is assumed to be rdev. In addition, the network library 3004d calls the method sendMessage( ) of the transmitting and receiving unit 3105 and, by providing, as the argument therefor, rdev and the generated content list transmission request message, transmits the content list transmission request message to the specified multimedia server. In addition, the network library 3004d calls the method receiveMessageHeader( ) of the transmitting and receiving unit 3105 and, by providing rdev for the argument, receives the header of a reply message from the multimedia server. In addition, the network library 3004d calls the method parseMessage( ) of the message processing unit 3104, by providing the received header for the argument. When analysis is successful, the network library 3004d then calls the method getResponseType( ) of the message processing unit 3104 and obtains an HTTP response code. When the response code is 200 indicating OK, the network library 3004d next calls the method receiveMessageBody( ) of the transmitting and receiving unit 3105 with the argument as rdev, and receives the details of the reply message. In addition, the network library 3004d calls the method parseMessage( ) of the message processing unit 3104, with the received reply message details as the argument, and causes the analysis of such details. When analysis is successful, the network library 3004d then calls the method getResponseType( ) of the message processing unit 3104, checks whether the return value is 1, and verifies whether it is a content list. When it is a content list, the network library 3004d further calls the method getContentList( ) of the message processing unit 3104 and accepts the received content list as an arrangement of ContentInfo instances. The received arrangement of the ContentInfo instances is merged with the arrangement of ContentInfo instances obtained up to this point. In addition, the network library 3004d calls the method closeConnection( ) of the transmitting and receiving unit 3105 and cuts-off the TCP connection. The network library 3004d repeats the same process on the next component in the arrangement of NetDevice instances received through the argument dev. After the process has been performed on all of the NetDevice instances, the method getContentList( ) of the control unit 3101 merges all of these into an arrangement of ContentInfo instances which serves as a return value, and the process ends.

Next, the operation of the method getMultimediaData( ) of the control unit 3101 shall be described. When this method is called, in the case where there is an extension header of an HTTP request to be transmitted to the multimedia server, the network library 3004d first generates such extension header as an arrangement of String variables. Next, by providing the value of the argument cont, the value of the argument offset, and the generated arrangement of the String variables for the argument, the network library 3004d calls the method createContentRequest( ) of the message processing unit 3104, causes it to generate an HTTP-GET request message which is content data transmission request, and receives this. Next, by providing the value of member variable dev of the argument cont as an argument, the network library 3004d calls the method connectToServer of the transmitting and receiving unit 3105, establishes a TCP connection with the multimedia server, and receives the RemoteDevice object as a return value. The received RemoteDevice object is assumed to be rdev. In addition, the network library 3004d calls the method sendMessage( ) of the transmitting and receiving unit 3105 and, by providing, as the argument therefor, rdev and the generated HTTP-GET request message, transmits the content transmission request message to the specified multimedia server. In addition, the network library 3004d calls the method receiveMessageHeader( ) of the transmitting and receiving unit 3105 and, by providing rdev for the argument, receives the header of a reply message from the multimedia server. In addition, the network library 3004d calls the method parseMessage( ) of the message processing unit 3104, by providing the received header for the argument. When analysis is successful, the network library 3004d then calls the method getResponseType( ) of the message processing unit 3104 and obtains an HTTP response code. When the response code is 200 indicating OK, the network library 3004d next receives the multimedia data by calling the method receiveData( ) of the transmitting and receiving unit 3105 with the argument as rdev and the value of argument os.

Next, the operation of the method createProperties( ) of the condition setting unit 3102 shall be described. When this method is called, the network library 3004d calls the method getDeviceProperties( ) of the attribute management unit 3103, and obtains the collection of the attributes of the content information receiving apparatus 102. The obtained collection of attributes shall be assumed to be p. Next, the network library 3004d checks the member variables of the ContentType instances provided by the argument ctype, and excludes from p, attributes of contents with a member variable of false. For example, in the case where the ctype member variables image and audio are false and video is true, the attributes such as formats compliant to still-picture contents and music contents are excluded from p, and attributes corresponding to MPEG2-TS are left included in p. After the aforementioned process is performed, p is assumed as the return value and the present method ends. Note that when the right to use protected video content is possessed, the property name is assumed as the DeviceID, and the value thereof must include the property which is the identifier of the content information receiving apparatus 102 issued by the broadcast station 106 or the content rights holder.

As described thus far, upon receiving from a terminal a list transmission request message for contents that can be provided, the content information outputting apparatus 101 included in the multimedia content communication system 105 according to the present embodiment generates, according to the attributes of the content or the attributes of the request-source terminal, such as compliant formats and the presence/absence of content use rights, a content list message of only contents that can be processed by the request-source terminal and transmits this to the terminal. Furthermore, the content information receiving apparatus 102 according to the present embodiment sets the search conditions to be used in the content list transmission request to the content information outputting apparatus 101, based on the attributes of the content information receiving apparatus 102, and issues a list transmission request message for contents that can be provided. This configuration produces the effect of enabling the content information outputting apparatus 101 to provide a list of only contents that can be used by a terminal, and eliminating the need for unnecessarily informing content for which use is limited such as contents requiring protection and the like. Furthermore, there is the effect of enabling the content information receiving apparatus 102 to obtain a list of only usable contents, and thus improving convenience.

(Other Variations)

Although the present invention is described based on the above-mentioned embodiments, it should be obvious that the present invention is not limited to such above-mentioned embodiments. The present invention also includes such cases as described below.

(1) In the content list transmission request to be transmitted from the content information receiving apparatus 102 to the content information outputting apparatus 102, as long as the property to be set as the search condition allows the media formats to be classified and allows the judgment of the classification to which a media format belongs, the same effect can be attained even when other properties are used. For example the media format Profile Name defined by the DLNA may also be used. In addition, it may likewise be uniquely specified.

(2) The judgment of the media format may be carried out using the analysis of the content data, the Content-Type, the file identifier, and so on. Furthermore, it may also be a method set by the user through the Java application.

(3) Although HTTP is used as the communication protocol for content data, other protocols such as RTP/RTSP may also be used.

(4) Although, in the above-described embodiment, only video contents are described as contents requiring protection, there are music and still-picture contents which require protection and it goes without saying that the same processing as in the protected video content in the above-described embodiment may also be carried on these.

(5) In the above-described embodiment, the content information receiving unit 102 stores the processing rights for protected contents, as an attribute, in the second memory 2903. However, it may also be obtained by inquiring to an external server or the broadcast station 106 prior to the list transmission request issuance. Furthermore, it may also be set by the lava application.

(6) In the above-described embodiment, the content information outputting apparatus 101 judges the contents to be included in the list, in accordance with the media format (MPEG2, JPEG, and MP3) of AV (Audio-Video) data to which the content information receiving apparatus is compliant. However, the contents to be included in the list may also be judged according to the format of data to be reproduced by being attached to the AV data. Here, the format of data to be reproduced by being attached to the AV data refers to a Java application, for example. More specifically, it refers to download-type data and application associated with a data broadcast, broadcast program in a broadcast standard, or an application associated with AV data, in a recording medium such as BD-ROM, and the like. In the case where the content information receiving apparatus 102 cannot reproduce or execute the format of data to be reproduced by being attached to the AV data, the content information outputting apparatus 101 does not include such AV data (content) in the list.

(7) Although, in the above-described embodiment, the content information outputting apparatus 101 and the content information receiving apparatus 102 use a Java application, an application program that can be imported via a broadcast signal may be used aside from the lava application.

(8) It is possible that a part or all of the constituent elements making up each of the above-mentioned apparatuses is made from one system LSI (Large Scale Integration circuit). The system LSI is a super multi-function LSI that is manufactured by integrating plural components in one chip, and is specifically a computer system which is configured by including a microprocessor, a ROM, a RAM, and so on. A computer program is stored in the RAM. The system LSI accomplishes its functions through the operation of the microprocessor in accordance with the computer program.

(9) It is possible that a part or all of the constituent elements making up each of the above-mentioned apparatuses is made from an IC card that can be attached to/detached from each apparatus, or a stand-alone module. The IC card or the module is a computer system made from a microprocessor, a ROM, a RAM, and so on. The IC card or the module may include the super multi-function LSI. The IC card or the module accomplishes its functions through the operation of the microprocessor in accordance with the computer program. The IC card or the module may also be tamper-resistant.

(10) The content information outputting apparatus and the content information receiving apparatus of the present invention may also be the method shown above. The present invention may also be a computer program for executing such methods through a computer, or as a digital signal made from the computer program.

Furthermore, the content information outputting apparatus and the content information receiving apparatus of the present invention may be a computer readable recording medium on which the computer program or the digital signal is recorded, such as a flexible disc, a hard disc, a CD-ROM, an MO, a DVD, a DVD-ROM, a DVD-RAM, a Blu-ray Disc (BD), a semiconductor memory, and so on. Furthermore, the content information outputting apparatus and the content information receiving apparatus of the present invention may also be the computer program or the digital signal recorded on such recording media.

Furthermore, the content information outputting apparatus and the content information receiving apparatus of the present invention may also be the computer program or the digital signal transmitted via an electrical communication line, a wireless or wired communication line, a network represented by the internet, a data broadcast, and so on.

Furthermore, the content information outputting apparatus and the content information receiving apparatus of the present invention may also be a computer system including a microprocessor and a memory, with the memory storing the computer program and the microprocessor operating in accordance with the computer program.

Furthermore, the present invention may also be implemented in another independent computer system by recording the program or digital signal on the recording medium and transferring the recording medium, or by transferring the program or the digital signal via the network, and the like.

(11) It is also possible to combine the above-described embodiment and the aforementioned variations.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The content information outputting apparatus, the content information receiving apparatus, and the multimedia content communication system of the present invention allows, in the sharing of multimedia content using a home network, a content list presented by a multimedia server to a client to include only usable contents such as contents in a media format to which the client is compliant, contents for which the client has use rights, and contents for which recording has been requested. Having the remarkable effect of increasing the protection effect for copyrights, privacy, and so on, together with providing the convenience of not having to select contents that the user can use, the content information outputting apparatus, the content information receiving apparatus, and the multimedia content communication system of the present invention is useful as a server apparatus, a receiving terminal, a device controlling apparatus, a data outputting method, a device controlling method, and the like, for multimedia content in a networked environment such as a home network.

What is claimed is:

1. A content information outputting apparatus which outputs multimedia contents representing at least one of video and audio to a terminal via a network, said content information outputting apparatus comprising:
an application execution unit operable to execute one or more application programs;
a storage unit for storing the multimedia contents;
a transmitting and receiving unit operable to transmit and receive a message to and from the terminal;
a message processing unit operable to process the message;
a content searching unit operable to search for a multimedia content falling within a range permitted by a certain application program among one or more of the application programs, from among the multimedia contents stored in said storage unit; and
a judgment unit operable to judge whether or not each of the multimedia contents stored in said storage unit can be outputted,
wherein, in the case where said transmitting and receiving unit receives, from the terminal, a request message for transmission of a list of the multimedia contents that can be outputted to the terminal by said content information outputting apparatus:
said message processing unit is operable to extract a search condition from the request message received by said transmitting and receiving unit, and pass the extracted search condition to said content searching unit;
said content searching unit is operable to search for the multimedia content falling within the range permitted by the application program, based on the received search condition and at least one of an attribute of the multimedia content and an attribute of the terminal;
said judgment unit is operable to judge, based on at least one of the attribute of the multimedia content and the attribute of the terminal, whether or not the multimedia content searched-out by said content searching unit can be outputted;
said message processing unit is operable to generate a content list message including information of a list of the multimedia content that is judged by said judgment unit as capable of being outputted, and to pass the generated content list message to said transmitting and receiving unit; and
said transmitting and receiving unit is operable to transmit the content list message to the terminal.

2. The content information outputting apparatus according to claim 1,
wherein said judgment unit is operable to judge whether or not the multimedia content searched-out by said content searching unit can be outputted, based on a judgment condition received from a certain application program among the one or more application programs.

3. The content information outputting apparatus according to claim 1,
wherein said judgment unit is operable to judge whether or not the multimedia content searched-out by said content searching unit can be outputted, by making an inquiry, to an external server, as to whether or not the multimedia content can be outputted.

4. The content information outputting apparatus according to claim 3,
wherein information identifying the external server is received from a certain application program among the one or more application programs.

5. The content information outputting apparatus according to claim 1, further comprising
a broadcast signal receiving unit operable to receive a broadcast signal including the multimedia content and the one or more application programs.

6. The content information outputting apparatus according to claim 1,
wherein the search condition is information specifying attributes of the multimedia content,
said content searching unit is operable to search for multimedia contents having an attribute specified by the search condition, from among the multimedia contents stored in said storage unit, and
for a multimedia content having an attribute for transmission only to a permitted terminal, among the multimedia contents searched-out by said content searching unit, said judgment unit is operable to judge that the multimedia content can be outputted in the case where the terminal has an attribute indicating that receiving of the multimedia content is permitted, and to judge that the multimedia content cannot be outputted in the case where the terminal has an attribute indicating that receiving of the multimedia content is not permitted.

7. A content information receiving apparatus which transmits, to a content information outputting apparatus, a request for multimedia content transmission and receives a multimedia content representing at least one of video and audio from the content information outputting apparatus, via a network, said content information receiving apparatus comprising:
an application execution unit operable to execute one or more application programs;
a transmitting and receiving unit operable to transmit and receive a message to and from the content information outputting apparatus;
a message processing unit operable to process the message; and
a search condition setting unit operable to set a search condition,
wherein, upon receiving a request from a certain application program among the one or more application programs:
said search condition setting unit is operable to set, as the search condition, an attribute of said content information receiving apparatus, and to pass the set search condition to said message processing unit;
said message processing unit is operable to generate a request message for transmission of a list of the multimedia content that can be outputted to said content information receiving apparatus by the content information outputting apparatus, and to pass the generated request message to said transmitting and receiving unit, the request message including the received search condition;
said transmitting and receiving unit is operable to transmit the received request message to the content information outputting apparatus, to receive a reply message from the content information outputting apparatus, and to pass the received reply message to said message processing unit; and
said message processing unit is operable to extract, from the received reply message, the list of the multimedia content that can be outputted to said content information receiving apparatus by the content information outputting apparatus, and to pass the extracted content list to the application program.

8. The content information receiving apparatus according to claim 7,
wherein information identifying the content information outputting apparatus with which communication is carried out is received from any application program among the one or more application programs.

9. The content information receiving apparatus according to claim 7,
wherein a certain application program among the one or more application programs passes a condition to said search condition setting unit, and
said search condition setting unit is operable to set the search condition with reference to the received condition.

10. The content information receiving apparatus according to claim 7,
wherein said search condition setting unit is operable to make an inquiry to an external server, and to set the search condition with reference to a condition obtained from the external server.

11. The content information receiving apparatus according to claim 10,
wherein information identifying the external server is received from a certain application program among the one or more application programs.

12. The content information receiving apparatus according to claim 7,
wherein the application program is obtained via a broadcast signal.

13. A content information outputting method for use in an apparatus which includes a storage unit and an application execution unit, and which outputs multimedia contents stored in the storage unit to a terminal via a network, the storage unit storing the multimedia contents representing at least one of video and audio, the application execution unit executing one or more application programs, said content information outputting method comprising the following, performed in the case where the apparatus receives, from the terminal, a request message requesting transmission of a list of the multimedia content that can be outputted to the terminal:
extracting a search condition from the request message;
searching for a multimedia content falling within a range permitted by a certain application program among the one or more application programs, from among the multimedia contents stored in the storage unit, based on the search condition and at least one of an attribute of the content and an attribute of the terminal;
judging whether or not the searched-out multimedia content can be outputted, based on at least one of the attribute of the multimedia content and the attribute of the terminal;
generating a content list message including information on the multimedia content that is judged as capable of being outputted; and
transmitting the content list message to the terminal.

14. A content information receiving method for use in an apparatus which includes an application execution unit, and which transmits a request for multimedia content transmission to a content information outputting apparatus and receives a multimedia content representing at least one of video and audio, from the content information outputting apparatus via a network, the application execution unit executing one or more application programs, said content information receiving method comprising the following, performed upon receiving a request from a certain application program among the one or more application programs:
setting an attribute of the apparatus as a search condition;
generating a request message requesting transmission of a list of the multimedia content that can be outputted to the apparatus by the content information outputting apparatus, the request message including the set search condition;
transmitting the request message to the content information outputting apparatus;
receiving a reply message from the content information outputting apparatus; and
extracting a list of multimedia content that can be outputted to the apparatus by the content information outputting apparatus, and passing the extracted list to the application program.

15. A multimedia content communication system comprising: a content information outputting apparatus which outputs multimedia contents representing at least one of video and audio, to a terminal via a network; and a content information receiving apparatus which transmits a request for transmission of multimedia contents to the content information outputting apparatus and receives a multimedia content from the content information outputting apparatus, said content information outputting apparatus and said content information receiving apparatus being connected to the same network,
wherein said content information outputting apparatus includes:
a first application execution unit operable to execute one or more application programs;
a storage unit for storing the multimedia contents;
a first transmitting and receiving unit operable to transmit and receive a message to and from said content information receiving apparatus;
a first message processing unit operable to process the message transmitted and received by said first transmitting and receiving unit;
a content searching unit operable to search for a multimedia content falling within a range permitted by a certain first application program among one or more of the first application programs, from among the multimedia contents stored in said storage unit; and
a judgment unit operable to judge whether or not each of the multimedia contents stored in said storage unit can be outputted,
wherein, in the case where said first transmitting and receiving unit receives, from said content information receiving apparatus, a request message for transmission of a list of the multimedia content that can be outputted to the terminal by said content information outputting apparatus:
said first message processing unit is operable to extract a search condition from the request message received by said first transmitting and receiving unit, and pass the extracted search condition to said content searching unit;
said content searching unit is operable to search for the multimedia content falling within the range permitted by the first application program, based on the received search condition and at least one of an attribute of the multimedia content and an attribute of the terminal;
said judgment unit is operable to judge, based on at least one of the attribute of the multimedia content and the attribute of the terminal, whether or not the multimedia content searched-out by said content searching unit can be outputted;
said first message processing unit is operable to generate a content list message including information of a list of the multimedia content that is judged by said judgment unit as capable of being outputted, and to pass the generated content list message to said first transmitting and receiving unit; and
said first transmitting and receiving unit is operable to transmit the content list message to the terminal,
said content information receiving apparatus includes:
a second application execution unit operable to execute one or more second application programs;
a second transmitting and receiving unit operable to transmit and receive a message to and from said content information outputting apparatus;
a message processing unit operable to process the message transmitted and received by said second transmitting and receiving unit; and
a search condition setting unit operable to set the search condition,
wherein, upon receiving a request from a certain second application program among the one or more second application programs:
said search condition setting unit is operable to set, as the search condition, an attribute of said content information receiving apparatus, and to pass the set search condition to said second message processing unit;
said second message processing unit is operable to generate the request message including the received search condition, and to pass the generated request message to said second transmitting and receiving unit;
said second transmitting and receiving unit is operable to transmit the received request message to the content information outputting apparatus, to receive the content list message from the content information outputting apparatus, and to pass the received content list message to said second message processing unit; and
said second message processing unit is operable to extract, from the received content list message, the list of the multimedia content that can be outputted to said content information receiving apparatus by the content information outputting apparatus, and to pass the extracted content list message to the second application program.
